(19) United States
(12) Patent Application Publication
(10) Pub. No.: US 2026/0166736 A1
(43) Pub. Date: Jun. 18, 2026

(54) ROBOTIC ARM CONTROL

(71) Applicant: Tencent Technology (Shenzhen) Company Limited, Shenzhen (CN)

(72) Inventors: Yihao HUANG, Shenzhen (CN); Shuai WANG, Shenzhen (CN)

(73) Assignee: Tencent Technology (Shenzhen) Company Limited, Shenzhen (CN)

(21) Appl. No.: 19/466,912

(22) Filed: Feb. 2, 2026

Related U.S. Application Data
(63) Continuation of application No. PCT/CN2024/120249, filed on Sep. 23, 2024.

(30) Foreign Application Priority Data
Oct. 7, 2023 (CN) 202311299143.2

(51) Int. Cl. B25J 9/16; B25J 18/00

(52) U.S. Cl. CPC B25J 9/1664; B25J 9/1653; B25J 18/00

(57) ABSTRACT

Historical data pairs at N moments are obtained. A historical data pair at a moment in the N moments includes input data at the moment, and output data at the moment, the input data controls a motion of a robotic arm at the moment, to cause a first object to be kept in a balanced state on the robotic arm, the output data represents poses of the robotic arm and the first object at the moment when the robotic arm is controlled based on the input data at the moment, and Nis a positive integer. Predicted input data of the robotic arm at a current moment is determined based on the historical data pairs at the N moments. Based on the predicted input data, a motion of the robotic arm at the current moment is controlled, the first object is balanced during the motion of the robotic arm.

### RELATED APPLICATIONS

The present application is a continuation of International Application No. PCT/CN2024/120249, filed on Sep. 23, 2024, which claims priority to Chinese Patent Application No. 202311299143.2, filed on Oct. 7, 2023. The entire disclosures of the prior applications are hereby incorporated by reference.

### FIELD OF THE TECHNOLOGY

Embodiments of this disclosure relate to the technical field of robots and automatic control, including techniques for robotic arm control.

### BACKGROUND OF THE DISCLOSURE

A robot is an automatically controlled machine that simulates a human operation. A robot in a form of a robotic arm may imitate actions of a human arm.

In a related art, tactile information of a bottle on the robotic arm is processed to obtain a position of the bottle on the robotic arm, and then a velocity of the bottle is obtained in a differential manner. The position of the bottle on the robotic arm and the velocity of the bottle are used as inputs of a proportional integral differential (PID) controller, and a rotation angle of a joint of the robotic arm is used as an output of the PID controller, to complete a task of balancing the bottle on the robotic arm.

However, in the foregoing method, the PID controller relies only on a feedback variable of the robotic arm, and is slow in response.

### SUMMARY

Embodiments of this disclosure provide a robotic arm control method and apparatus, a device, a robot, a storage medium, and a program product. The technical solutions are as follows.

Some aspects of the disclosure provide a method for robotic arm control. For example, historical data pairs at N moments are obtained. A historical data pair at a moment in the N moments includes input data at the moment, and output data at the moment, the input data controls a motion of a robotic arm at the moment, to cause a first object to be kept in a balanced state on the robotic arm, the output data represents poses of the robotic arm and the first object at the moment when the robotic arm is controlled based on the input data at the moment, and N is a positive integer. Predicted input data of the robotic arm at a current moment is determined based on the historical data pairs at the N moments. Based on the predicted input data, a motion of the robotic arm at the current moment is controlled, the first object is balanced during the motion of the robotic arm.

Some aspects of the disclosure provide an apparatus that includes processing circuitry configured to perform the method for robotic arm control.

Some aspects of the disclosure also provide a non-transitory computer-readable storage medium storing instructions which when executed by at least one processor cause the at least one processor to perform the method for robotic arm control.

According to an aspect of embodiments of this disclosure, a robotic arm control method is provided, including: obtaining historical data pairs at N moments, a historical data pair including historical input data and historical output data, the historical input data being configured for controlling motion of a robotic arm, to cause a first object to be kept in a balanced state on the robotic arm, the historical output data being configured for representing poses of the robotic arm and the first object after the robotic arm is controlled, based on the historical input data, to perform motion, and N being a positive integer; determining predicted input data of the robotic arm based on the historical data pairs at the N moments; and controlling, based on the predicted input data, the robotic arm to perform motion, the first object being balanced during motion of the robotic arm.

According to an aspect of embodiments of this disclosure, a robotic arm control apparatus is provided, including: an obtaining module, configured to obtain historical data pairs at N moments, a historical data pair including historical input data and historical output data, the historical input data being configured for controlling motion of a robotic arm, to cause a first object to be kept in a balanced state on the robotic arm, the historical output data being configured for representing poses of the robotic arm and the first object after the robotic arm is controlled, based on the historical input data, to perform motion, and N being a positive integer; a determining module, configured to determine predicted input data of the robotic arm based on the historical data pairs at the N moments; and a control module, configured to control, based on the predicted input data, the robotic arm to perform motion, the first object being balanced during motion of the robotic arm.

According to an aspect of embodiments of this disclosure, a robotic arm is provided, including a processor and a memory, the memory storing a computer program, and the computer program being loaded and executed by the processor to implement the robotic arm control method.

According to an aspect of embodiments of this disclosure, a computer-readable storage medium is provided, storing a computer program, the computer program being loaded and executed by a processor to implement the robotic arm control method.

According to an aspect of embodiments of this disclosure, a computer program product is provided, including a computer program, the computer program being stored in a computer-readable storage medium (e.g., non-transitory computer-readable storage medium). A processor (an example of processing circuitry) of a robot reads the computer program from the computer-readable storage medium, and the processor executes the computer program, to cause the robot to perform the robotic arm control method.

The technical solutions provided in embodiments of this disclosure may have the following beneficial effects:

Historical data pairs at a plurality of moments are obtained, input data of the robotic arm is predicted to obtain predicted input data, and motion of the robotic arm is controlled based on the predicted input data, to complete the task of balancing the first object on the robotic arm. A future system state of the robotic arm is predicted based on historical data without only depending on a feedback variable of a robotic arm system. Therefore, a response to control is more rapid.

### BRIEF DESCRIPTION OF THE DRAWINGS

FIG. 1 is a flowchart of a robotic arm control method according to an embodiment of this disclosure.

FIG. 2 is a schematic diagram of a balancing task of a first object on a robotic arm according to an embodiment of this disclosure.

FIG. 3 is a schematic diagram of a balancing task of a first object on a robotic arm according to another embodiment of this disclosure.

FIG. 4 is a schematic diagram of a robotic arm control method according to an embodiment of this disclosure.

FIG. 5 is a simplified schematic diagram of a dynamics model according to an embodiment of this disclosure.

FIG. 6 is a block diagram of a robotic arm control method using a dynamics model according to an embodiment of this disclosure.

FIG. 7 is a schematic diagram of a coordinate system of a robotic arm according to an embodiment of this disclosure.

FIG. 8 is an architectural diagram of a robotic arm control method according to an embodiment of this disclosure.

FIG. 9 is a schematic diagram of a 7-degree-of-freedom robotic arm according to an embodiment of this disclosure.

FIG. 10 is a schematic diagram of a 3-degree-of-freedom shoulder joint according to an embodiment of this disclosure.

FIG. 11 is a schematic diagram of an overall shoulder joint according to an embodiment of this disclosure.

FIG. 12 is a front view and a side view of a differential mechanism according to an embodiment of this disclosure.

FIG. 13 is a schematic diagram of an implementation principle of a differential mechanism according to an embodiment of this disclosure.

FIG. 14 is a cross-sectional view of a differential mechanism according to an embodiment of this disclosure.

FIG. 15 is a schematic diagram of an upper arm drive module according to an embodiment of this disclosure.

FIG. 16 is a schematic diagram of a wrist joint motor drive module and an elbow joint motor drive module according to an embodiment of this disclosure.

FIG. 17 is a cross-sectional view of a connection of a middle shaft according to an embodiment of this disclosure.

FIG. 18 is a block diagram of a robotic arm control apparatus according to an embodiment of this disclosure.

FIG. 19 is a block diagram of a robotic arm control apparatus according to another embodiment of this disclosure.

FIG. 20 is a block diagram of a robot according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

A robotic arm can be used in industrial production and academic research. However, common usage is mainly to use an end of the robotic arm or a mechanical arm to complete some operation tasks. Few people use a rigid body connecting member and a housing of the robotic arm to complete a corresponding operation task, and there are few applications that use the housing of the robotic arm to complete a corresponding operation task. Main reasons are as follows:
(1) An appearance of the robotic arm is usually designed to be curved, and does not have a large plane.
(2) A graspable mechanism, for example, a hand is not designed, and contact between the appearance of the robotic arm and an external object does not form a form closure and a force closure, causing excessively great control difficulty;
(3) The housing of the robotic arm basically has no tactile perception, and consequently, feedback that lacks perception makes it very difficult to implement control.

Different from a related technology, in embodiments of this disclosure, provided are an action of balancing an object placed on a housing of a lower arm of the robotic arm and keeping the object not from sliding off the lower arm of the robotic arm in this process, and an implementation method thereof. The specific method includes:
(1) Design of a control architecture
(2) Use of a tactile sensor
(3) Design of a controller

In the method provided in embodiments of this disclosure, operations may be performed by a computer device. The computer device may be a device configured to control a robotic arm, or may be a robotic arm. When the computer device is a robotic arm, the robotic arm is an electronic device having data calculation, processing, and storage capabilities. The robotic arm provided in embodiments of this disclosure may be used in scenarios such as industry (for example, an industrial robot), service (for example, a dish serving robot), entertainment (for example, a performing robot), or medical treatment (for example, a medical robot). This is not limited in embodiments of this disclosure.

Solutions provided in embodiments of this disclosure relate to a technology, for example, artificial intelligence (AI) automation control. This can implement control of the robotic arm. Details are described by using the following embodiments.

In the related art, a PID is used as a controller, tactile information of a bottle on a robotic arm is processed to obtain a position of the bottle, and then a velocity is obtained in a differential manner. The position and the velocity are used as an input of the PID controller, and a rotation angle of a joint of the robotic arm is used as an output of the PID controller, to complete a bottle balancing task.

However, the method using the PID controller may be limited as follows:

(1) The PID controller is sensitive to external interference and noise, which may cause degradation of control performance.

(2) The PID controller can only process a single-variable case, and another control method needs to be used for a multi-variable system.

(3) The PID controller alone has no feedforward and responds slowly, and the PID plays a control role only after an error occurs.

(4) A velocity or even an acceleration in an input signal of the PID controller is obtained through differential calculation, an error is very large, and noise is introduced. Therefore, high jitter exists in a control amount of the PID obtained based on the input signal obtained through differential calculation.

(5) The PID is a linear controller, and when a controlled system has a large nonlinear factor, the PID controller cannot control a controlled object.

In embodiments of this disclosure, the foregoing problems can be overcome through data driven model predictive control (DD MPC), to implement a balancing task of an object (including but not limited to a bottle) on the robotic arm. In embodiments of this disclosure, the following effects can be achieved:

(1) A data driven MPC controller considers interference of noise, has a better adaptive feature and robustness, and an output amount does not jitter due to input noise.

(2) The data driven MPC controller can simultaneously control a plurality of controlled variables.

(3) The data driven MPC can predict a future system state based on historical data without only depending on a system feedback variable. Therefore, the data driven MPC responds to control more rapidly.

(4) The data driven MPC may consider some real constraints, for example, an upper limit and a lower limit of a joint position of the robotic arm, an upper limit and a lower limit of a joint velocity of the robotic arm, and an upper limit and a lower limit of a joint acceleration of the robotic arm, so that a control variable obtained by the controller meets the real constraints.

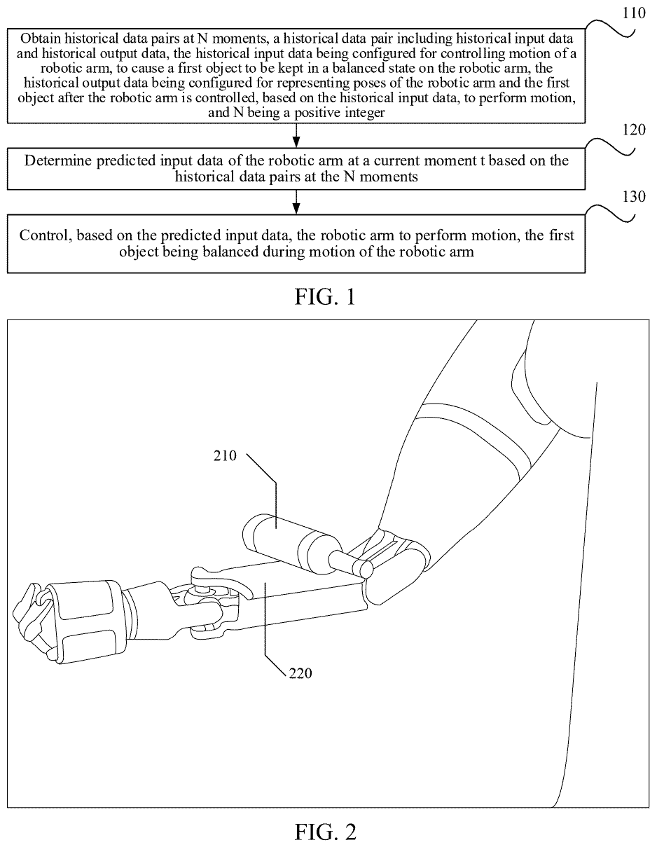

FIG. 1 is a flowchart of a robotic arm control method according to an embodiment of this disclosure. In this embodiment, descriptions are made mainly by using an example in which the method is applied to the robotic arm described above. The method may include the following several operations (110 to 130). For ease of description, a first object placed on the robotic arm is mainly described by using a bottle as an example.

Operation 110: Obtain historical data pairs at N moments, a historical data pair including historical input data and historical output data, the historical input data being configured for controlling motion of a robotic arm, to cause the first object to be kept in a balanced state on the robotic arm, the historical output data being configured for representing poses of the robotic arm and the first object after the robotic arm is controlled, based on the historical input data, to perform motion, and N being a positive integer.

Both the historical input data and the historical output data correspond to a current moment t, the historical input data is configured for controlling the robotic arm to perform motion to cause the first object on the robotic arm to be kept in the balanced state, and the historical output data is configured for identifying the poses of the robotic arm and the first object after the robotic arm performs motion. Therefore, the historical input data may also be recorded as prior control data, and the historical output data may also be recorded as prior pose data. Historical input data and historical output data at a same historical moment may be recorded as one historical data pair.

In some embodiments, for the current moment t, historical data pairs at the N moments before the current moment t are obtained.

In some embodiments, for any moment t, historical data pairs at the N moments before the moment t are obtained.

In some embodiments, the N moments may be consecutive N moments, or may be non-consecutive N moments. This is not limited in this disclosure.

In some embodiments, a time interval between any two consecutive moments in the N moments is the same. For example, N=3, where a time interval between a moment 1 and a moment 2 is the same as a time interval between the moment 2 and a moment 3.

In some embodiments, the robotic arm is controlled to perform motion based on input data, and during motion of the robotic arm, the first object is kept balanced on the robotic arm without falling off.

In some embodiments, the first object may change a relative position between the first object and the robotic arm as the robotic arm performs motion.

A type, a shape, and the like of the first object are not limited in this disclosure. For example, the first object may be a cylindrical object, for example, a bottle. Alternatively, the first object may be a spherical object, for example, a ping-pong ball.

In some embodiments, corresponding input data at a moment may include one or more pieces of data. This is not limited in this disclosure. For example, the robotic arm may include a shoulder joint, an elbow joint, and a wrist joint, and the input data may include a rotation angle of one or more joints.

In some embodiments, corresponding output data at a moment may include one or more pieces of data. This is not limited in this disclosure. For example, the output data may include one or more pieces of data of an angle between the robotic arm and a horizontal plane, a position of the first object on the robotic arm, and a rotation angle of the one or more joints of the robotic arm.

Operation 120: Determine predicted input data of the robotic arm at a current moment t based on the historical data pairs at the N moments.

In some embodiments, an input of the robotic arm at a current moment is predicted based on the historical data pairs at the N moments, to obtain the predicted input data of the robotic arm.

In some embodiments, a DD MPC controller is used to determine the predicted input data of the robotic arm based on the historical data pairs at the N moments.

In some embodiments, the predicted input data may be one or more of parameters for controlling motion of the robotic arm. How to control the motion of the robotic arm may be determined based on the predicted input data. For example, the predicted input data may be a torque, or may be a rotation angle of a joint of the robotic arm.

The predicted input data and the historical input data have similar functions, and are both configured for controlling motion of the robotic arm, so that the first object is kept in the balanced state on the robotic arm. A difference lies in a moment for control. The predicted input data is configured for performing motion control on the robotic arm at the current moment t, and the historical input data is configured for performing motion control on the robotic arm at the N moments before the current moment t.

Operation 130: Control, based on the predicted input data, the robotic arm to perform motion, the first object being balanced during motion of the robotic arm.

In some embodiments, for the current moment t, the robotic arm is in a first form, and the robotic arm is controlled to perform motion based on the predicted input data to be in a second form. In this process, the first object is kept in the balanced state on the robotic arm.

In some embodiments, with motion of the robotic arm, the first object also performs motion relative to the robotic arm.

The motion of the robotic arm in this embodiment of this disclosure is motion of the robotic arm relative to the ground. During motion of the robotic arm, the first object may also perform motion relative to the ground. However, due to a change of the angle of the robotic arm relative to the horizontal plane, a force bearing condition of the first object changes, and the first object may also perform motion relative to the robotic arm.

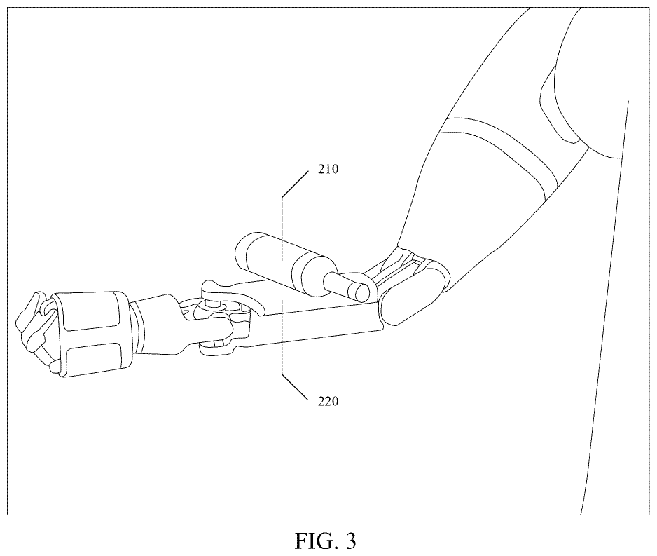

For example, as shown in FIG. 2, a first object 210 is located on a lower arm of a robotic arm 220. In this case, the robotic arm is in a first form, the robotic arm 220 performs motion based on the predicted input data to be in a third form shown in FIG. 3. In this case, a relative position between the first object 210 and the robotic arm 220 changes.

In some embodiments, a motion range of the first object on the robotic arm may include the entire robotic arm, or may include only a part of the robotic arm. For example, the first object may perform motion on an upper arm, the lower arm, and an end of the robotic arm, or may perform motion only on the lower arm of the robotic arm.

In the technical solutions provided in embodiments of this disclosure, historical data pairs at a plurality of moments are obtained, so that input data of the robotic arm is predicted to obtain predicted input data, and motion of the robotic arm is controlled based on the predicted input data, to complete a task of balancing the first object on the robotic arm. A future system state of the robotic arm is predicted based on historical data without only depending on a feedback variable of a robotic arm system. Therefore, a response to control is more rapid.

In some embodiments, the robotic arm may be considered as a linear time-invariant system (LTI). Basic properties of the LTI system are: linearity (homogeneity and additivity), time-invariance, differentiation, and integration.

In some embodiments, a system parameter of the linear time-invariant system does not change with time. Therefore, when a unit impulse response is known, input data of the LTI system is determined, and corresponding output data may be obtained based on a system state of the LTI system. Conversely, when input data, output data, and a system state of the LTI system are known, a unit impulse response may be obtained through solving. In this embodiment of this disclosure, descriptions are provided by using an example in which a joint (or referred to as a rotation joint) of the robotic arm is controlled. Therefore, the robotic arm may be considered as an LTI system. The process of determining the predicted input data of the robotic arm in this embodiment of this disclosure may be considered as a process of solving the unit impulse response. In consideration of existence of many errors, noise, and the like in reality that affect the robotic arm, unit impulse responses obtained through solving based on different historical data pairs may differ. Therefore, a constraint of a real condition needs to be considered during solving of the unit impulse response, and a value of the unit impulse response also needs to be adjusted based on feedback of the robotic arm (output data corresponding to the robotic arm in the second form after the robotic arm performs motion based on the predicted input data) and an ideal balanced state of the robotic arm. The unit impulse response is actually a unit impulse response sequence. For ease of description, the name of the unit impulse response or the unit impulse response sequence may be used in embodiments of this disclosure.

In addition, if a plurality of joints (or referred to as rotation joints) of the robotic arm need to be controlled, an actual situation of the robotic arm needs to be analyzed, and the robotic arm cannot be simply considered as an LTI system.

In this embodiment of this disclosure, the robotic arm system may be considered as an LTI system shown in Formula (1) below:

$$[ \begin{matrix}{H}_{L} ( {u}^{d} ) \\ {H}_{L} ( {y}^{d} )\end{matrix} ] α = [ \begin{matrix}\overline{u} \\ \overline{y}\end{matrix} ] \qquad ( 1 )$$

α represents the unit impulse response, ū represents the predicted input data, y̅ represents predicted output data, H_{L}(u^{d}) and H_{L}(y^{d}) represents a hankel matrix, L represents a predicted step of the robotic arm, and u^{d} and y^{d} represents an (L+n)^{th} order sustainability excitation historical track of the robotic arm system. A sustainability excitation historical track indicates that a system state and properties represented by the track are stable, that is, first n track points (where a track point is a historical data pair at a moment) may be used to predict track points in the future with a length of L (mapped to first n rows and last L rows of a matrix corresponding to the hankel matrix).

In this embodiment of this disclosure, input data or output data at a moment is referred to as a track.

$${H}_{L} ( x ) := [ \begin{matrix}{x}_{0} & & {x}_{1} & & {x}_{N - 1} \\ & & & ⋯ & \\ {x}_{1} & & {x}_{2} & & {x}_{N - L + 1} \\ & ⋮ & & ⋱ & ⋮ \\ {x}_{L - 1} & & {x}_{L} & ⋯ & {x}_{N - 1}\end{matrix} ] \qquad ( 2 )$$

x represents historical data (which may be the historical input data or the historical output data), x_{N-L} represents historical data from an N^{th} moment to an L^{th} moment, and N represents an amount of historical data.

In some embodiments, when a quantity of categories of the historical data is not 1, a dimension of the hankel matrix is (m*L+m*n)×(N−L−n+1). m represents the quantity of categories of the historical data, and n represents a system order of the robotic arm.

Formula (1) may be considered as an expression of a convolution sum of a discrete LTI system in time domain. A meaning of the formula may be understood as follows: If any output obtained by multiplying a by the hankel matrix exists, the output is definitely a track ū and y̅ of the LTI system.

The foregoing formula implicitly expresses a model of the system by using a segment of historical data of the LTI system, to replace M, namely, a model, in the MPC by using the historical data.

In some embodiments, operation 120 may be implemented as at least one operation (not shown) of the following operations 121 to 123.

Operation 121: Construct a constraint function and a cost function of the robotic arm based on the historical data pairs at the N moments, the constraint function being configured for describing a constraint condition that data needs to meet, the cost function being configured for representing a difference between predicted data and balance data, the balance data including input data and output data when the robotic arm and the first object are in an ideal balanced state, the predicted data including the predicted input data and predicted output data, and the predicted output data being obtained through prediction based on the historical output data.

In some embodiments, the constraint function is configured for describing a constraint of a real condition that the robotic arm needs to meet. In some embodiments, the cost function may also be considered as a loss function, and is configured for describing a difference between the predicted data and the balance data.

In some embodiments, the ideal balanced state is a state in which when the input data of the robotic arm is 0, the robotic arm does not perform motion, in other words, the output data of the robotic arm does not change relative to output data at a previous moment. For example, the first object performs motion on the lower arm of the robotic arm. The ideal balanced state may be that the lower arm of the robotic arm is parallel to the horizontal plane, the first object is located at a midpoint of the lower arm of the robotic arm, and a plane formed by a centroid position of the first object and a midline of the robotic arm is perpendicular to the horizontal plane.

In some embodiments, operation 121 may be implemented as at least one operation (not shown) of the following operations a to c.

Operation a: Determine a first matrix and a second matrix, the first matrix including historical input data in the historical data pairs at the N moments, and the second matrix including historical output data in the historical data pairs at the N moments.

In some embodiments, the historical input data in the historical data pairs at the N moments is determined as an element in the first matrix, and the historical output data in the historical data pairs at the N moments is determined as an element in the second matrix.

In some embodiments, historical input data from an (i−1)^{th} moment to an (N−L−n+i−1)^{th} moment in the N moments is determined as an i^{th} row of the first matrix; and historical output data from an (i−1)^{th} moment to an (N−L−n+i−1)^{th} moment in the N moments is determined as an i^{th} row of the second matrix, where i is a positive integer.

In some embodiments, the first matrix is H_{L}(u^{d}) in Formula (1), and the second matrix is H_{L}(y^{d}) in Formula (1).

Operation b: Construct the constraint function of the robotic arm based on first n rows in the first matrix and first n rows in the second matrix, n being a system order of the robotic arm, and n being a positive integer.

In some embodiments, because the constraint function is configured for describing a constraint of the real condition on the robotic arm, there may be one or more constraint functions.

In some embodiments, the constraint function includes a first constraint function, a second constraint function, a third constraint function, and a fourth constraint function.

In some embodiments, the first constraint function is constructed based on a slack variable, the slack variable being configured for describing measurement noise, and the first constraint function being configured for reducing interference of the measurement noise on the predicted input data.

In some embodiments, because measurement noise exists in a real scenario, the slack variable is introduced. An objective of introducing the slack variable is to allow y with measurement noise to be substituted into a hankel matrix equation (Formula (1)) to still ensure that the equation is satisfied (where y in an ideal hankel matrix equation is noise free).

In some embodiments, the first constraint function is represented by Formula (3) below:

$$[ \begin{matrix}\overline{u} ( t ) \\ \overline{y} ( t ) + σ ( t )\end{matrix} ] = [ \begin{matrix}{H}_{L + n} ( {u}^{d} ) \\ {H}_{L + n} ( {\tilde{y}}^{d} )\end{matrix} ] α ( t ) \qquad ( 3 )$$

σ(t) represents the slack variable, ū(t) represents the predicted input data, y̅(t) represents the predicted output data, α(t) represents the unit impulse response, H_{L+n}(u^{d}) represents a hankel matrix formed by the historical input data at the N moments, and H_{L+n}(\tilde{y}^{d}) represents a hankel matrix formed by the historical output data at the N moments.

In some embodiments, the second constraint function is constructed based on the first n rows in the first matrix and the first n rows in the second matrix, the second constraint function being configured for describing the historical data pairs at the first n moments.

In some embodiments, the second constraint function is configured for expressing that −n^{th} to −1^{st} historical input data ū and historical output data y̅ of the LTI system at a moment t are first n historical data pairs of the LTI system at a current moment. This may be understood as different descriptions of a same segment of LTI track with a length of n.

In some embodiments, the second constraint function is represented by Formula (4) below:

$$[ \begin{matrix}{\overline{u}}_{[ - n , - 1 ]} ( t ) \\ {\overline{y}}_{[ - n , - 1 ]} ( t )\end{matrix} ] = [ \begin{matrix}{u}_{[ t - n , t - 1 ]} \\ {\tilde{y}}_{[ t - n , t - 1 ]}\end{matrix} ] \qquad ( 4 )$$

ū_{[-n,-1]}(t) represents −n^{th} to −1^{st} pieces of predicted input data at the moment t, y̅_{[-n,-1]}(t) represents the −n^{th} to −1^{st} pieces of historical output data at the moment t, u_{[t-n,t-1]} represents first n pieces of historical input data at the current moment t, and \tilde{y}_{[t-n,t-1]} represents first n pieces of historical output data at the current moment t.

In some embodiments, the third constraint function is constructed based on the first n rows in the first matrix, the first n rows in the second matrix, and the balance data, the third constraint function representing that the robotic arm is approximately in the ideal balanced state as time goes by.

In some embodiments, the third constraint function is a constraint corresponding to a quadratic programming issue in the data driven MPC controller. The equality constraint is referred to as a terminal equality constraint. The terminal equality constraint is generally for limiting a final value of an optimization variable during optimization to be equal to a specific target value, for example, to cause the system to be in a specific target state in a control scenario. For example, in this embodiment of this disclosure, the robotic arm is approximately in the ideal balanced state.

In some embodiments, the third constraint function is represented by Formula (5) below:

$$[ \begin{matrix}{\overline{u}}_{[ L - n , L - 1 ]} ( t ) \\ {\overline{y}}_{[ L - n , L - 1 ]} ( t )\end{matrix} ] = [ \begin{matrix}{u}_{n}^{s} \\ {y}_{n}^{s}\end{matrix} ] , {\overline{u}}_{k} ( t ) ∈ U \qquad ( 5 )$$

ū_{[L-n,L-1]}(t) represents predicted input data that is of the LTI system and whose length is n from a (t+L−n) moment to a (t+L−1) moment, y̅_{[L-n,L-1]}(t) represents output data that is of the LTI system and whose length is n from the (t+L−n) moment to the (t+L−1) moment, and

$${u}_{n}^{s} and {y}_{n}^{s}$$

represent balance points of the LTI system at the N moments, where s represents the balance points, and n represents that the balance points are written into a column vector with a length of n.

Because a track from the (t+L−n) moment to the (t+L−1) moment is unknown, prediction can be performed only based on a property of the LTI system and sustainability excitation historical data. Therefore, in a control procedure, a track of first n points is updated in real time to update the equality constraint. The “terminal” in the terminal equality constraint may be understood as a state that the system finally reaches: a balance point. The terminal equality constraint may be written, based on the hankel matrix equation of the LTI system, into a corresponding form of the hankel matrix multiplied by a. In this way, the terminal equality constraint is converted into an equation about a.

In some embodiments, the balance point is an ideal balanced state.

In some embodiments, an ideal balanced state at each moment is the same.

In some embodiments, the fourth constraint function is constructed based on the slack variable, a first boundary point, and the unit impulse response, the first boundary point being an upper limit of the slack variable, and the fourth constraint function being configured for constraining convergence of a process of predicting the predicted input data.

In some embodiments, the fourth constraint function is represented by Formula (6) below:

$${‖ {σ}_{k} ( t ) ‖}_{∞} \leq \overline{ε} ( 1 + {‖ α ( t ) ‖}_{1} ) , k ∈ {II}_{[ 0 , L - 1 ]} \qquad ( 6 )$$

σₖ(t) represents the slack variable, ε̅ represents the upper limit of the slack variable, namely, the first boundary point, and α(t) represents the unit impulse response.

In some embodiments, when λ_{σ} is selected to be large enough, the fourth constraint function can be absolutely satisfied because a regularization term of σ becomes very small through penalty by λ_{σ}. Therefore, this inequality constraint is not considered in the quadratic programming issue. λ_{σ} represents a penalty weight for the slack variable.

Operation c: Construct the cost function of the robotic arm based on last L rows in the first matrix and last L rows in the second matrix, L being a predicted step of the robotic arm, and L being a positive integer.

In some embodiments, a first norm is constructed based on the last L rows in the first matrix and the last L rows in the second matrix, where the first norm includes a second-order square norm of historical input data at the last L moments in the N moments, and a second-order square norm of historical output data at the last L moments in the N moments; a first penalty term is constructed based on a first penalty weight, a first boundary point, and a first regular term, the first regular term being a regularization penalty for the unit impulse response, the first penalty weight being a penalty weight for the first regular term, the first boundary point being an upper limit of a slack variable, and the slack variable being configured for describing measurement noise; a second penalty term is constructed based on a second penalty weight and a second regular term, the second regular term being a regularization penalty for the slack variable, and the second penalty weight being a penalty weight for the second regular term; and the cost function is constructed based on the first norm, the first penalty term, and the second penalty term.

In some embodiments, historical data pairs of the robotic arm at first n moments are configured for predicting input data and output data of the robotic arm at last L moments.

In some embodiments, the cost function is represented by Formula (7) below:

$${J}_{L}^{*} ( {u}_{[ t - n , t - 1 ]} , {y}_{[ t - n , t - 1 ]} ) = {min}_{{α ( t ) , σ ( t )}_{\overline{u} ( t ) , \overline{y} ( t )}} {\sum }_{k = 0}^{L - 1} Lim ( {\overline{u}}_{k} ( t ) , {\overline{y}}_{k} ( t ) ) + {λ}_{α} \overline{ε} {‖ α ( t ) ‖}_{2}^{2} + {λ}_{σ} {‖ σ ( t ) ‖}_{2}^{2} \qquad ( 7 )$$

$$Lim ( \overline{u} , \overline{y} ) = {‖ \overline{u} - {u}^{s} ‖}_{R}^{2} + {‖ \overline{y} - {y}^{s} ‖}_{Q}^{2}$$

Lim(ū,y̅) represents a square of a second norm between the input data and the output data and balance points corresponding to the input data and the output data, R represents a penalty weight matrix of a square of a second norm between the input data and the balance point of the input data, and Q represents a penalty weight matrix of a square of a second norm between the output data and the balance point of the output data.

$${λ}_{α} \overline{ε} {‖ α ( t ) ‖}_{2}^{2}$$

represents a regularization penalty for α, and aims to avoid overfitting in a process of solving in the quadratic programming issue, and reduce an equation error caused by the hankel matrix. λ_{α} represents a penalty weight for this regular term, and ε̅ represents the upper limit of the slack variable.

$${λ}_{σ} {‖ σ ( t ) ‖}_{2}^{2}$$

represents a regularization penalty for the slack variable σ. λ_{σ} represents a penalty weight for this regular term. The slack variable is often used to change an inequality constraint in optimization into an equality constraint, so that a feasible solution domain in the optimization is larger, and solution is easier. Finally, the hankel matrix equation that can implicitly represent the LTI system model is used to replace data sequences of u and y in the cost function. Therefore, last L rows of the hankel matrix are used, to ensure that matrix dimensions on both sides of the equation are correct, so that the cost function is converted into an equation about α.

Operation 122: Calculate a unit impulse response of the robotic arm based on the constraint function and the cost function, the unit impulse response being configured for representing feedback from the robotic arm for the predicted input data.

In some embodiments, both the cost function and the constraint function are converted into functions about α, so that α that minimizes the cost function and satisfies the equality constraint can be obtained for the entire quadratic programming issue.

Operation 123: Determine predicted input data of the robotic arm based on the unit impulse response.

In some embodiments, the predicted input data of the robotic arm is determined based on the unit impulse response and the historical input data pairs at the N moments.

In some embodiments, a third matrix is determined based on the historical input data pairs at the N moments, the third matrix including a first matrix and a second matrix, the first matrix including historical input data in the historical data pairs at the N moments, and the second matrix including historical output data in the historical data pairs at the N moments; and the predicted input data of the robotic arm is calculated based on the unit impulse response and the third matrix.

In some embodiments, the third matrix is the hankel matrix on a left side of the hankel matrix equation in Formula (1), and the predicted input data is ū on a right side of the equation.

According to the foregoing method, the balancing task of the first object on the robotic arm is considered as a solving task of the discrete LTI system. A unit impulse response of the LTI system is obtained through solving, and the predicted input data of the robotic arm is predicted based on the unit impulse response. This solution is easier. A constraint of the real condition is considered in the process, so that the predicted input data obtained through prediction can meet the real constraint condition. In addition, impact of the measurement noise on the output data is described by using the slack variable, and interference of the noise is considered. This has a better adaptive feature and robustness.

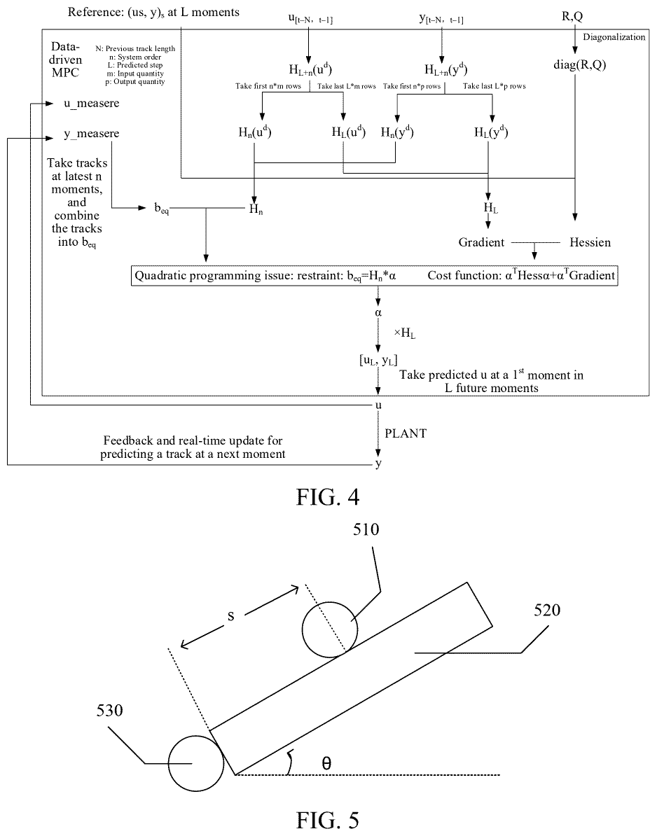

For example, FIG. 4 is a working flowchart of a DD MPC controller according to an embodiment of this disclosure. 1. Collect a historical system track with a length of N. 2. Construct a hankel matrix by using the historical track. 3. The hankel matrix (where the hankel matrix is decomposed into first n rows and last L columns in the hankel matrix, the first n rows are configured for forming a terminal equality constraint, and the last L columns are configured for forming a Hessien matrix and a gradient matrix in the quadratic programming issue), a reference matrix, and an RQ penalty weight matrix are substituted into a cost function and the terminal equality constraint, to form a quadratic programming issue about α. 4. Solve, by using a quadratic programming solver (for example, qpOASES), α that minimizes the cost function and satisfies the equality constraint. 5. Return α to the hankel matrix equation to obtain a corresponding input/output track and extract predicted input data u. 6. Send the predicted input data u to a robotic arm for execution. 7. Use first n input/output track points at a current moment for updating the terminal equality constraint as feedback. 8. It is set that t=t+1, and perform operation 4 again until a system is in a balanced state.

In some embodiments, a type of input data and a type of output data of the robotic arm may be inferred by using the dynamics model, or may be deduced without using the dynamics model. In this embodiment of this disclosure, descriptions are provided below.

### 1. A Dynamics Model is Used

In some embodiments, a dynamics equation of the robotic arm is constructed based on the motion parameter of the first object and the motion parameter of the robotic arm.

The motion parameter includes at least one parameter affecting kinetic energy or potential energy, the dynamics equation includes an underdrive equation and a drive equation, the underdrive equation is an equation whose input torque is 0, and the drive equation is an equation whose input torque is not 0.

In some embodiments, the motion parameter includes at least one of the following: a length of the robotic arm, a specification of the first object, a mass of the robotic arm, a mass of the first object, a moment of inertia of the robotic arm, and a moment of inertia of the first object.

In some embodiments, categories of the parameters included in the motion parameter of the first object and categories of the parameters included in the motion parameter of the robotic arm may be the same or different.

In some embodiments, a state space equation of the robotic arm is constructed based on the underdrive equation and the third matrix, the state space equation being configured for describing a motion state of the robotic arm; and the predicted input data is calculated based on the state space equation and the drive equation.

In some embodiments, a first state space equation of the robotic arm is constructed based on the third matrix, and the first state space equation is processed based on the underdrive equation, to obtain the state space equation.

In some embodiments, an input torque is calculated based on the state space equation and the drive equation, the input torque being configured for controlling rotation of a joint of the robotic arm; and the input torque is determined as the predicted input data.

In some embodiments, an initial dynamics equation of the robotic arm is constructed based on a motion parameter of the bottle and the motion parameter of the robotic arm; and partial feedback linearization is performed on the initial dynamics equation to obtain the dynamics equation, the partial feedback linearization being to perform linearized approximation on the initial dynamics equation.

In some embodiments, partial feedback linearization is to initialize a parameter in the initial dynamics equation to a parameter that meets a linearization requirement. For example, when θ approaches 0, sin θ is initialized to θ.

For example, for a scenario in which the bottle is balanced on a housing of the lower arm of the robotic arm, a process of performing dynamics modeling on the robotic arm obtained through abstraction based on the scenario is described as follows:

First, the robotic arm is in a world coordinate system. A direction of an extension line of the lower arm of the robotic arm is defined as a positive direction of a y-axis. A direction perpendicular to the y-axis and parallel to the ground is defined as an x-axis direction. A direction of a right hand is a positive direction of an x-axis when standing in a same direction with the robotic arm. A direction opposite to the gravity, vertical upward, and perpendicular to the ground is a z-axis direction. In this way, spatial rectangular coordinate system is established. To implement control of a robot for balancing the bottle, a two-dimensional model may be established on a YOZ plane.

A simplified diagram of the two-dimensional model on the YOZ plane is shown in FIG. 5. An upper circle 510 represents a cross section of the bottle, a lower long rectangle 520 represents a side of the lower arm of the robotic arm, and a circle 530 on the long rectangle 520 represents a rotation shaft (for example, an elbow joint of the robotic arm) for rotation of the lower arm. A first issue is considered as a homogeneous rigid body, and a position of the bottle is evaluated by using a centroid of the bottle. The bottle and the lower arm are approximately vertically disposed.

Physical quantities (motion parameters) used in the two-dimensional model and positive directions of the physical quantities are defined as follows: A distance between the centroid of the bottle and an axis of the rotation shaft of the robotic arm along a horizontal direction of the side of the robotic arm is represented by s. A torque for rotating the rotation shaft of the robotic arm is represented by τ, an anticlockwise direction is a positive direction of the torque, and an angle of rotation of the lower arm relative to the world coordinate system is represented by θ. A length of the side of the lower arm is represented by lₐ, a radius of the bottle is represented by r_{b}, a mass of the lower arm is represented by mₐ, a mass of the bottle is represented by m_{b}, a moment of inertia of the lower arm is represented by Iₐ, and a moment of inertia of the bottle is represented by I_{b}.

For example, the physical quantities used in the two-dimensional model are defined as follows:
Length of the lower arm: lₐ=0.27 m
Radius of the bottle: r_{b}=0.0325 m
Mass of the lower arm: mₐ=2.48 kg
Mass of the bottle: m_{b}=0.24 kg
Moment of inertia of the lower arm: Iₐ=0.03
Moment of inertia of the bottle: I_{b}=2.535e-04

Linear velocity of motion of the bottle may be expressed as follows:

$${v}^{2} = {\dot{s}}^{2} + {( s \dot{θ} )}^{2}$$

Angular velocity of rotation of the bottle may be expressed as follows:

$$ω = \frac{\dot{s}}{{r}_{b}} + \dot{θ}$$

According to the Euler Lagrange equation, kinetic energy and potential energy of all rigid bodies in the system need to be solved, and a sum of the kinetic energy and the potential energy of all the rigid bodies in the system are expressed as follows:

$$T = \frac{1}{2} {I}_{b} \cdot {( \frac{\dot{s}}{{r}_{b}} + \dot{θ} )}^{2} + \frac{1}{2} {m}_{b} ( {\dot{s}}^{2} + {s}^{2} {\dot{θ}}^{2} ) + \frac{1}{2} {I}_{a} {\dot{θ}}^{2}$$

A sum of the potential energy of all the rigid bodies in the system is expressed as follows:

$$U = \frac{1}{2} {m}_{a} g \cdot {l}_{a} sin θ + {m}_{b} gs \cdot sin θ$$

Offsets of kinetic energy to a state s (where the state s is a position s of the bottle on the lower arm) and θ in an extended coordinate (generalized coordinate) system thereof are expressed as follows:

$$\frac{d}{dt} ( \frac{\partial T}{\partial \dot{s}} ) = ( \frac{{T}_{b}}{{r}_{b}^{2}} + {m}_{b} ) \ddot{s} + \frac{{I}_{b}}{{r}_{b}} \ddot{θ}$$

$$\frac{d}{dt} ( \frac{\partial T}{\partial \dot{θ}} ) = \frac{{I}_{b}}{{r}_{b}} \ddot{s} + ( {I}_{b} + {I}_{a} - {m}_{b} {s}^{2} ) \ddot{θ} + 2 {m}_{b} s \dot{θ} \dot{θ}$$

$$\frac{\partial T}{\partial s} = {m}_{b} {\dot{θ}}^{2} s$$

$$\frac{\partial T}{\partial \dot{θ}} = 0$$

Offers of the potential energy to the states s and θ in the extended coordinate system thereof are as follows:

$$\frac{\partial U}{\partial s} = {m}_{b} g sin θ$$

$$\frac{\partial U}{\partial \dot{θ}} = ( \frac{1}{2} {m}_{a} {gl}_{a} + {m}_{b} gs ) cos θ$$

It can be learned through calculation on the foregoing results according to the Euler Lagrange equation that, in a system on the plane YOZ, simplification of the dynamics model may be expressed below. A 1^{st} row represents a dynamics equation in an s-degree-of-freedom (where the s-degree-of-freedom is the position s of the bottle on the lower arm). In this direction, an actual input torque on a right side of the equation is 0 due to underdrive. A 2^{nd} row represents a dynamics equation in a degree of freedom of a rotation angle θ of the lower arm, and drive in the degree of freedom is the torque τ. Therefore, τ is on a right side of the equation on the 2^{nd} row.

$$( \frac{{I}_{b}}{{r}_{b}^{2}} + {m}_{b} ) \ddot{s} + \frac{{I}_{b}}{{r}_{b}} \ddot{θ} - {m}_{b} s {\dot{θ}}^{2} + {m}_{b} g sin θ = 0$$

$$\frac{{I}_{b}}{{r}_{b}^{2}} \ddot{s} + ( {I}_{b} + Ia - {m}_{b} {s}^{2} ) \dot{θ} + 2 {m}_{b} s \dot{s} \ddot{θ} + ( \frac{1}{2} {m}_{a} {gl}_{a} + {m}_{b} gs ) cos θ = τ$$

Generally, an underdrive part (namely, an expression being 0 on the right side of the equation) in the dynamics model is introduced into the state space equation, so that the state space equation for describing a system considers dynamics of the system.

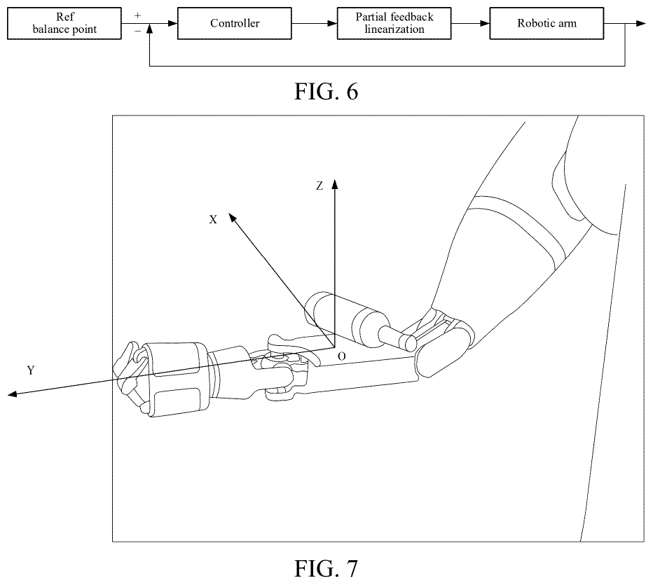

Based on an input and an output of the dynamics model, input data u of the robotic arm is set as a rotation angular acceleration \ddot{θ} of a rotation joint, and output data y is set as an angle θ and an angular velocity \dot{θ} of the rotation joint, and the position s of the bottle on the arm and a velocity \dot{s} of the bottle. When written into the state space equation, first three rows are simple differential relationships between state variables, and a last row of the state space equation includes the underdrive part of the dynamics model. The balance point (ideal balanced state) ref is set as follows: Balance points of all (angular) velocities and (angular) accelerations are 0 (and a corresponding unit). A balance point of the rotation angle of the joint is 0 rad (a derived dynamics simplified model is 0 rad, and a corresponding real robotic arm is 0.465 rad). A balance point s of the bottle on the arm is the midpoint of the lower arm (a derived dynamics simplified model is 0.135 m, and a corresponding real robotic arm is 22 (where 22 is a 22^{th} column of a tactile sensor array arranged on the robotic arm)). Generally, if a motor of the robotic arm can be controlled by using a torque, partial feedback linearization is usually performed on a dynamics system model, to obtain a system model after linearization and an expression between a torque τ and a new control amount v introduced through partial feedback linearization. The former is configured for design of the controller, and the latter is configured for converting an output v (namely, the new control amount introduced through partial feedback linearization) of the controller into the torque τ, and then sending the torque τ to the robotic arm. The entire control procedure is shown in FIG. 6.

In this embodiment of this disclosure, \ddot{θ} is directly used as the new control amount v, and partial feedback linearization is as follows: 1. When θ is about 0 and slightly changes, sin θ is approximately linearized to θ. 2. When θ is about 0 and slightly changes, \dot{θ}² is approximately linearized to 0.

After partial feedback linearization is performed, a dynamics underdrive equation is introduced into the state space equation. The state space equation is expressed as follows:

$$[ \begin{matrix}\dot{θ} \\ \ddot{θ} \\ \dot{s} \\ \ddot{s}\end{matrix} ] = [ \begin{matrix}0 & 1 & 0 & 0 \\ 0 & 0 & 0 & 0 \\ 0 & 0 & 0 & 1 \\ - \frac{{m}_{b} g}{( \frac{{l}_{b}}{{r}_{b}^{2}} + {m}_{b} )} & 0 & 0 & 0\end{matrix} ] [ \begin{matrix}θ \\ \dot{θ} \\ s \\ \dot{s}\end{matrix} ] + [ \begin{matrix}0 \\ 1 \\ 0 \\ \frac{- \frac{{l}_{b}}{{r}_{b}^{2}}}{( \frac{{l}_{b}}{{r}_{b}^{2}} + {m}_{b} )}\end{matrix} ] \ddot{θ}$$

A dynamics drive equation is used as an expression between the torque t and the new control amount v (\ddot{θ} herein) that is introduced through partial feedback linearization:

$$\frac{{I}_{b}}{{r}_{b}^{2}} \ddot{s} + ( {I}_{b} + Ia - {m}_{b} {s}^{2} ) \dot{θ} + 2 {m}_{b} s \dot{s} \ddot{θ} + ( \frac{1}{2} {m}_{a} {gl}_{a} + {m}_{b} gs ) cos θ = τ$$

According to the foregoing descriptions, the input data and the output data of the robotic arm are determined through the dynamics model. In this case, the input data of the robotic arm is the rotation angular acceleration \ddot{θ} of the rotation joint, and the output data is the angle θ and the angular velocity \ddot{θ} of the rotation joint, and the position s of the bottle on the arm and the velocity \dot{s} of the bottle.

g in the foregoing formula represents a gravity acceleration.

In some embodiments, when the dynamics model is used, a rotation angular velocity of a joint of the robotic arm is calculated based on the unit impulse response and the third matrix; and the rotation angular velocity is determined as the predicted input data of the robotic arm at the current moment t.

### 2. No Dynamics Model is Used

When an input and an output of the system are selected without using the dynamics model, input data is set as a rotation angle θ of the rotation joint, and the output is set as an integral ∫s dt of a position of the first object on the arm and an error with respect to time, and the position s and a velocity \dot{s} of the first object on the arm. The balance point (ideal balanced state) ref is set as follows: Balance points of all (angular) velocities are 0 (and a corresponding unit). A balance point of the rotation angle of the joint is 0 rad (a derived dynamics simplified model is 0 rad, and a corresponding real robotic arm is 0.465 rad). A balance point s of the bottle on the arm is the midpoint of the lower arm (a derived dynamics simplified model is 0.135 m, and a corresponding real robotic arm is 22 (where 22 is a 22^{th} column of a tactile sensor array arranged on the robotic arm)).

θ represents an angle that is in a pitch direction and by which the lower arm of the robotic arm rotates about a y-axis. \dot{θ} represents an angular velocity that is in the pitch direction and in which the lower arm of the robotic arm rotates about the y-axis. τ represents a control torque in the pitch direction applied for rotation of the lower arm of the robotic arm about the y-axis. s represents an offset, in a y-axis direction, between a centroid of the first object and a center of gravity of the lower arm of the robotic arm, and \dot{s} represents an offset velocity, in the y direction, between a centroid of the bottle and the center of gravity of the lower arm of the robotic arm.

In some embodiments, an acceleration signal \ddot{θ} cannot be accurately collected and sent to the robotic arm due to restrictions of hardware conditions. Therefore, the input and the output of the system can be selected without using the dynamics model.

In some embodiments, historical data pairs at a plurality of consecutive historical moments before the current moment t are obtained for the current moment t; and the historical data pairs at the plurality of consecutive historical moments are uniformly sampled, to obtain the historical data pairs at the N moments.

For example, a historical data pair (including historical input data and historical output data) whose length is N=1000 in the past is collected. A formed hankel matrix is excessively large due to an excessively large N, and consequently, a computing burden and computing time of a computer device are significantly increased. Therefore, sampling is performed at intervals, one point in input/output data is taken every four points, system historical data with a length of 1000 is compressed to a length of 200, and then input to the DD MPC controller. This can effectively reduce the computing burden and the computing time of the computer device. In addition, a length of prediction horizon is set to 50. All penalty weights involved in the DD MPC are adjusted.

Finally, the first object is placed on the lower arm of the robotic arm, the first object suffers interference, and the rotation angle θ of the rotation joint is output through the DD MPC, to control the robotic arm to complete the balancing task of the first object on the robotic arm.

This disclosure also provides an embodiment on how to obtain the historical output data at the N moments.

In some embodiments, pose identification may be performed on the first object by using a visual perception method. However, in the method, a linear error of 1 to 2 centimeters and an angle error of 5 to 10 degrees may occur, and operation time is long, about 100 ms, namely, 10 Hz.

In some embodiments, an engineered visual solution may be used. To be specific, a lightweight data image processing manner is used to determine a position of the centroid of the first object in an x direction. There are a plurality of specific implementations. This is not limited in this disclosure. For example, the first object is a bottle. Cluster analysis is performed based on different colors of the bottle and objects in a surrounding environment, to further obtain a geometric center of the bottle, and then the pose of the first object is obtained model calibration of the geometric center and the centroid position of the first object. For another example, the first object is a bottle. Feature identification is performed on the bottle to determine a position of the bottle in an image and further determine a geometric center of the bottle, and then the pose of the first object is obtained model calibration of the geometric center and the centroid position of the first object. In the method, lightweight computing is performed, a computing speed is fast, basically, one operation only needs about 10 ms, that is, nearly 100 Hz. Therefore, a linear error is controllable, usually about 1 cm, and an angle error is about 5 degrees. However, a disadvantage of the method is that there is a large error in a depth direction of a camera, that is, a y direction of a world coordinate system of the bottle. For content (for example, the x direction and the y direction) of the coordinate system in the foregoing content, refer to the coordinate system described in the embodiment of the dynamics model. Details are not described again in this disclosure.

This error is exactly an advantage of the tactile sensor. Although the tactile sensor cannot obtain a very accurate result for the pose in the x direction, and can only obtain an absolute position of a contact point between the first object and the robotic arm relative to the robotic arm, position measurement by the tactile sensor on the contact point between the first object and the robotic arm in the y direction of the robotic arm is very accurate. Therefore, a state of the first object may be estimated by using advantages of the visual manner and the tactile manner.

In some embodiments, a visual and tactile fusion solution may be used. For example, the tactile sensor provides a position and a pitch pose of the bottle in the y direction. In addition, lightweight visual data image processing is performed for comparison with prior photograph data, to determine the centroid position of the bottle in the x direction. Budget time of this solution is about 10 milliseconds, that is, 100 Hz, a linear error is about 1 cm, and an angle error is about 5 degrees. This is similar to the engineered visual solution, but a disadvantage of inaccurate measurement of the centroid of the first object in the y direction in the engineered visual solution is overcome.

For example, as shown in FIG. 7, in the engineered visual solution, an accurate pose of a first object 710 in the x direction may be obtained, and in the visual and tactile fusion solution, an accurate pose of the first object 710 in the y direction may be obtained. Through combination, an accurate centroid position of the first object 710 may be obtained. Table 1 shows needed periods and corresponding errors of the foregoing three solutions.

TABLE 1
Three solutions for determining the pose of the first object

| | | | | Linear | | Angle |
|---|---|---|---|---|---|---|
| Solutions | Method descriptions | Period | | error | | error |
| Visual | Recognition of a 6-dimensional pose by | 100 | ms | 1-2 | cm | 5-10° |
| perception | using a system method | | | | | |
| solution | | | | | | |
| Engineered | Lightweight visual data image processing, | 10 | ms | 1 | cm | 5° |
| visual solution | to determine the centroid position of the | | | | | |
| | bottle in the x direction | | | | | |
| Visual and | The position and a roll pose of the bottle in | 10 | ms | 1 | cm | 5° |

| | |
|---|---|
| tactile fusion | the x direction are provided based on |
| solution | tactility, and visual color photo matting is |
| | performed for comparison with prior photo |
| | data to determine the centroid position of |
| | the bottle in the y direction. |

The visual and tactile fusion solution is used, and the obtaining the historical data pairs at the N (historical) moments may include at least one of the following operations 1 to 7:

Operation 1: Obtain, for a j^{th} moment in the N moments, historical input data at the j^{th} moment, j being a positive integer less than or equal to N.

Operation 2: Determine a pose of the robotic arm after the robotic arm performs motion based on the historical input data at the j^{th} moment.

Operation 3: Obtain a first position of the first object on the robotic arm based on a tactile sensor.

Operation 4: Obtain an image of the first object at the j^{th} moment.

Operation 5: Obtain a second position of the first object on the robotic arm based on the image of the first object.

Operation 6: Determine a centroid position of the first object based on the first position and the second position.

Operation 7: Determine historical output data of the robotic arm at the j^{th} moment based on the centroid position of the first object and the pose of the robotic arm after the robotic arm performs motion based on the historical input data at the j^{th} moment.

In some embodiments, the first position and the second position may be represented in a form of coordinates (x, y), where coordinates corresponding to the first position are (x1, y1), and coordinates corresponding to the second position are (x2, y2).

Based on the descriptions of the visual and tactile fusion solution in the foregoing content, the first position is accurate in the y direction, and the second position is accurate in the x direction. Therefore, the centroid position of the first object may be determined as (x2, y1).

The method of obtaining the second position of the first object on the robotic arm based on the image of the first object in operation 5 is not limited in this disclosure. For example, a feature identification method may be used to determine a position of the first object in the image of the first object, to determine a geometric center of the first object, and determine the second position based on the geometric center of the first object.

In some embodiments, categories of data included in the historical output data may be determined on whether the dynamics model is used. For example, if the dynamics model is used, the historical output data includes the centroid position of the first object, the velocity of the first object, the angle of the rotation joint of the robotic arm, the angular velocity of the rotation joint of the robotic arm, and the angular acceleration of the rotation joint of the robotic arm. If the dynamics model is not used, the historical output data includes the centroid position of the first object, the velocity of the first object, and an integral of the centroid position of the first object and an error with respect to time.

According to the foregoing method, an accurate position of the first object on the robotic arm can be obtained, to provide strong support for the balancing task of the first object on the robotic arm.

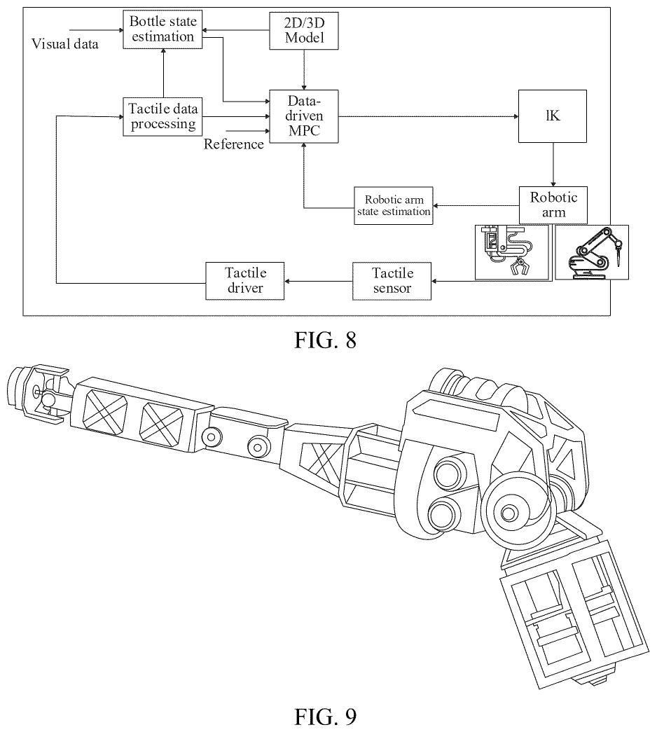

An overall control architecture implementing the foregoing functions is shown in FIG. 8. A final objective is to control the balancing task of the first object on the robotic arm by inputting an instruction for a joint motor of the robotic arm. A joint encoder is mounted on each joint motor of the robotic arm, so that a rotation angle, an angular velocity, and current information of the joint motor can be fed back. The information may be configured for state estimation of the robotic arm. In addition, tactile sensors are further mounted on fingers, a palm, and some links of the robotic arm. A positional pose of the bottle and a two-dimensional or three-dimensional system dynamics model between the first object and the lower arm are obtained based on tactile perception information through state estimation. The system dynamics model may be two-dimensional or three-dimensional. An input and an output of the robotic arm may be determined by using the system dynamics model. Therefore, data that needs to be collected by the data driven MPC controller may be collected based on the input and the output of the robotic arm that are determined by using the dynamics model. The data driven MPC controller is designed based on a collected historical data pair. The first object is placed on the lower arm of the robotic arm, the first object suffers interference, and the data driven MPC controller outputs corresponding predicted input data to complete the balancing task of the first object on the robotic arm. The predicted input data may be a variable in joint space or a variable in Cartesian space based on different robotic arms. If the predicted input data is a variable in Cartesian space, a joint angle of each joint needs to be calculated based on inverse kinematics. As time goes by, the controller outputs an end pose of the robotic arm or a sequence of link centroid poses. Therefore, corresponding to a series of inverse kinematics solutions, a sequence of joint angles and joint angular velocities of the robotic arm is obtained. The sequence of the joint angles and the joint angular velocities is sent to the robotic arm, so that control of the end pose of the robotic arm or a centroid position and a centroid pose of a link can be implemented. If the predicted input data is a variable in the joint space, for example, a joint angle, an angular velocity, or an angular acceleration, the predicted input data may be directly sent to the robot to complete the balancing task of the first object on the robotic arm.

In this embodiment of this disclosure, a real machine experiment is performed using a bottle as the first object. In the real machine experiment, the bottle may roll back and forth on the lower arm of the robotic arm, and a motion state of the bottle changes as an absolute pose between the lower arm of the robotic arm and the ground changes. The bottle may alternatively roll on the lower arm by controlling the joint motor of the robotic arm. In the whole process, the bottle is balanced, and does not fall to the ground when performing motion on the lower arm of the robotic arm. In the real machine experiment, the action sequence in this embodiment of this disclosure is interpreted, and effectiveness and stability of the control architecture and the controller in this embodiment of this disclosure are proved.

An embodiment of this disclosure further provides related information of hardware of the robotic arm. All the robotic arm control methods in the foregoing embodiments can be implemented on the robotic arm.

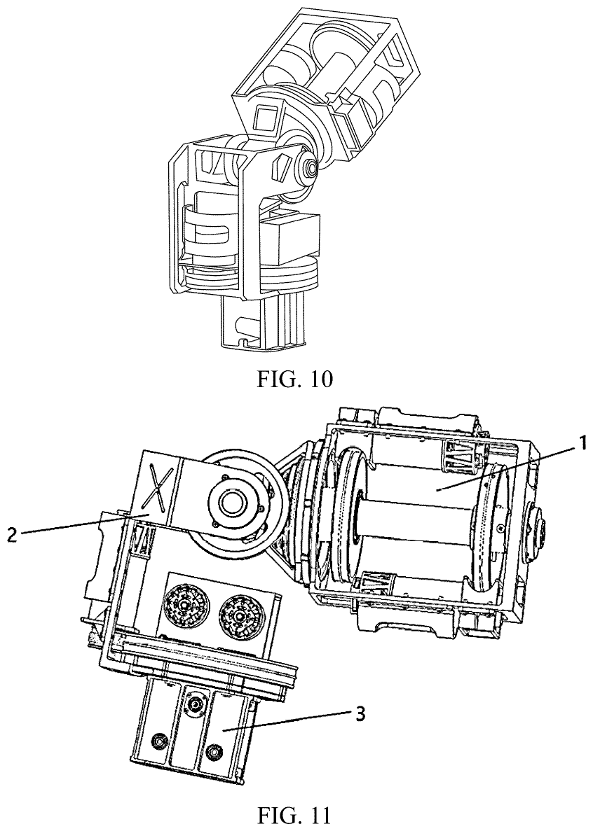

FIG. 9 shows a human-like 7-degree-of-freedom robotic arm. An elbow control motor and a wrist control motor are disposed behind a hollow part of a third joint of a shoulder, an elbow rope drive and a wrist rope drive are driven by a motor at a part 3 of the shoulder to a rope wheel, and the rope wheel performs corresponding motion control on a wrist and an elbow by using a belt drive rope. A 3-degree-of-freedom shoulder joint structure is shown in FIG. 10. A quantity of joints whose motion can be independently implemented by a robot mechanism is referred to as a motion degree of freedom of the robot mechanism, which is represented by a DOF for short. Currently, a control method used in an industrial robot is to use each joint on a robotic arm as an independent servo mechanism, that is, each shaft corresponds to one server, and each server is controlled through a bus, and is uniformly controlled by a controller and coordinately operates.

In a low-inertia differential shoulder joint structure used in a 7-degree-of-freedom robotic arm, a differential rope drive mechanism is used at the shoulder. This not only reduces a weight of the mechanism and disposes a motor module behind, but also implements torque superposition in some cases. A third degree of freedom of the shoulder joint uses a pair of large and small wire wheels, and transmission is performed in a rope driving manner. This further improves transmission precision and reduces a weight. Finally, drive modules of the wrist joint and the elbow joint are placed behind a shoulder joint upper arm module, so that a weight of the entire robotic arm is extremely reduced. The foregoing structure is easy to be modularized and simplifies a manufacturing procedure.

FIG. 11 is an overall view of a shoulder joint. It can be seen that the shoulder joint is mainly divided into three modules: a differential mechanism module 1, a cross roll bearing rotation module 2, and an upper arm end drive module 3. The cross roll bearing rotation module 2 is an intermediate module connecting the differential mechanism 1 and the upper arm end drive module 3. The three modules are described in detail below.

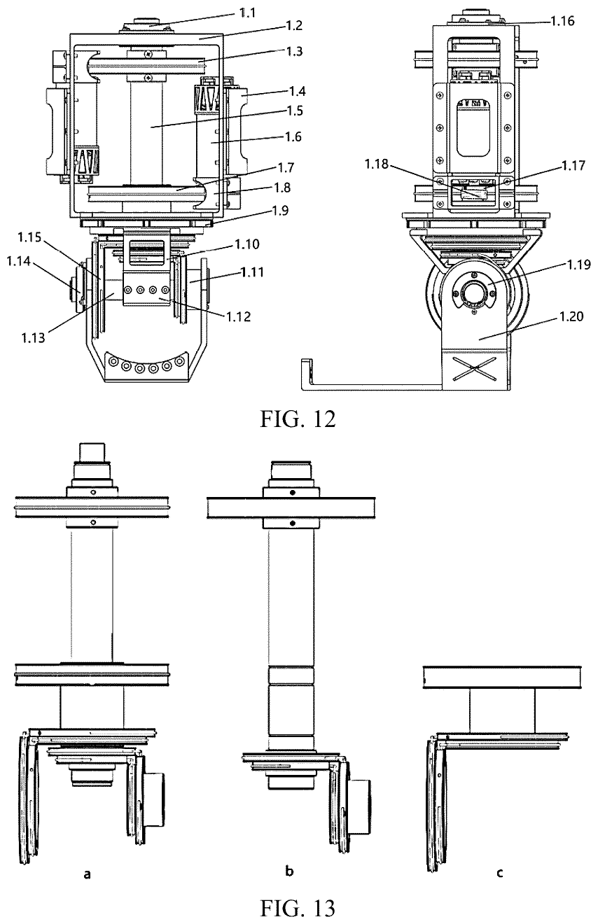

FIG. 12 is a front view and a side view of a differential mechanism module, such as the differential mechanism module 1 in an example. Main parts are marked one by one in FIG. 12, and parts in complex shapes and connection manners are introduced one by one below. It can be learned from FIG. 12 that, the entire differential mechanism includes a rotary encoder 1.1, a differential mechanism fixing base 1.2, a large wire wheel 1.3, a motor protective cover 1.4, a differential mechanism inner ring shaft 1.5, a motor 1.6, a differential mechanism outer ring shaft 1.7, a motor base 1.8, a cross roll bearing outer ring end cap 1.9, a cross roll inner ring fixing base 1.10, a differential mechanism small wire wheel 1.11, a connection block 1.12, a connection shaft 1.13, a rotary encoder 1.14, a differential mechanism large wire wheel 1.15, a bearing end cap 1.16, a small wire wheel 1.17, a steel rope 1.18, a bearing end cap 1.19, and an upper arm connecting seat 1.20. The following describes a specific composition and operating principle of the entire differential mechanism. An operating principle of the entire differential mechanism is similar to that of three bevel gears. The operating principle of the differential mechanism is shown in FIG. 13. It can be seen that FIG. 13a shows a main body of the entire differential mechanism, including the large wire wheel 1.3, the differential mechanism inner ring shaft 1.5, the differential mechanism outer ring shaft 1.7, the differential mechanism small wire wheel 1.11, the differential mechanism large wire wheel 1.15, and the steel wire wound on the differential mechanism. The differential mechanism small wire wheel 1.11 and the differential mechanism large wire wheel 1.15 are fastened to the upper arm connecting seat 1.20 by using screws. Cooperation between the differential mechanism inner ring shaft 1.5 and the differential mechanism small wire wheel 1.11 of the differential mechanism is shown in FIG. 13b, and cooperation between a gear pair of the differential mechanism is implemented. Driving is performed by using the large wire wheel 1.3 that is connected to the differential mechanism inner ring shaft 1.5 by using a screw and the small wire wheel 1.17 matching the large wire wheel 1.3. FIG. 3c shows another gear pair including the differential mechanism outer ring shaft 1.7 and the differential mechanism large wire wheel 1.15. It can be seen that the differential mechanism large wire wheel 1.5 and the differential mechanism outer ring shaft 1.7 are connected in a form of socket shaft. A specific structure is described below. A transmission shaft 1.21 in FIG. 13a is connected to a connection block 1.12, and is responsible for transmitting rotation of the entire differential mechanism to the rotary encoder 1.1.

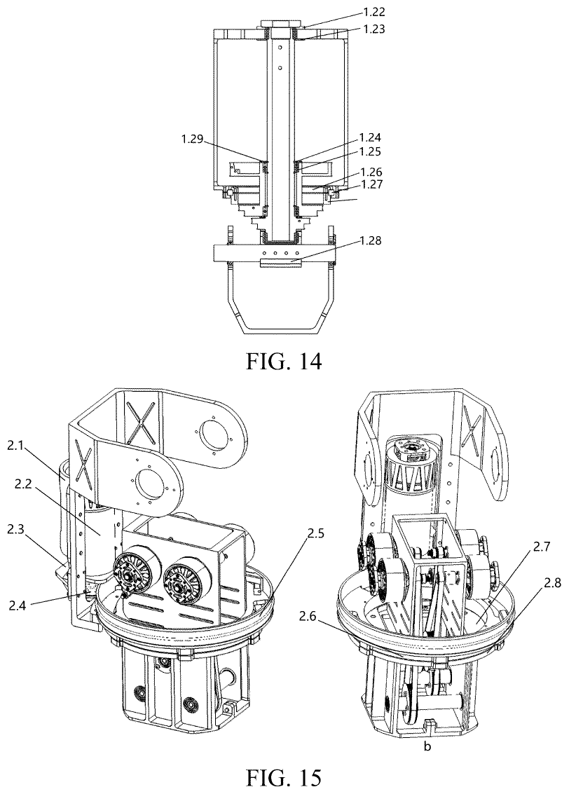

FIG. 14 shows a sectional view of the differential mechanism. Because the differential mechanism small wire wheel 1.11 and the differential mechanism large wire wheel 1.15 are connected to the upper arm connecting seat 1.20 by using screws, a connection manner is not described in FIG. 14. It can be seen that in FIG. 14, an outer ring of the rotary encoder 1.1 is fastened to a connecting pressure plate 1.22 by using a nut, and an inner ring of the rotary encoder 1.1 is clamped by the nut and a shaft shoulder of the transmission shaft 1.21, so that the inner ring rotates together with the transmission shaft 1.21, and a pressing plate 1.23 rotates together with the connecting pressure plate 1.22 to press against an outer ring of a deep groove ball bearing 1.25 (all bearings in FIG. 14 are deep ball bearings, and are denoted by only one numeral). A connection between the differential mechanism inner ring shaft 1.5 and the differential mechanism outer ring shaft 1.7 is similar to the foregoing connection. There are two deep groove ball bearings 1.25 at upper and lower ends of the differential mechanism outer ring shaft 1.7. A bearing inner ring is fastened by using the shaft shoulder and a snap spring 1.24 of the differential mechanism inner ring shaft 1.5. An outer ring is fastened by using the shaft shoulder and a bearing pressing plate 1.29 of the differential mechanism outer ring shaft 1.7. The connection between the differential mechanism inner ring shaft 1.5 and the cross roll inner ring fixing base 1.10 and the connection block 1.12 slightly differs from the foregoing connection, and pressing is implemented through inner and outer rings of the bearing. Details are not described again. The connection shaft 1.13 and the connection block 1.12 are fixed and limited by using a key 1.28 and a screw. In FIG. 14, the cross roll bearing 1.27 is fastened by the cross roll inner ring fixing base 1.10 and the cross roll bearing inner ring cover plate 1.26, and the outer ring is fastened by the differential mechanism fixing seat 1.2 and the cross roll bearing outer ring end cap 1.9. The connection between the upper arm connecting seat 1.20 and the connection shaft 1.13 also uses a deep groove ball bearing, and is fixed by pressing inner and outer rings of the deep groove ball bearing.

FIG. 15 is a view of an arm drive module. Because a structure of this part is complex, the arm drive module is described in two parts. One part is a shoulder size wire drive module. One part is a wrist joint motor drive module and an elbow joint motor drive module. The shoulder size wire drive module mainly includes a motor protection housing 2.1, a motor 2.2, a motor fastening seat 2.3, a small wire wheel 2.4, a large wire wheel 2.5, a cross roll bearing outer ring fixed upper cover plate 2.6, a cross roll bearing inner ring fixed lower cover plate 2.7, and a cross roll bearing outer ring fixed lower cover plate 2.8. In fact, a structure of this module does not greatly differ from the structure of the foregoing differential mechanism. The large wire wheel 2.5 and the small wire wheel 2.4 are arranged tangent to each other. The small wire wheel 2.4 is connected to the motor 2.2 to form a driving source. The motor 2.2 is fixed on the upper arm connecting seat 1.20. The rotation module also consists of a cross roll bearing 2.22. A lower end of the large wire wheel 2.5 and a cross roll bearing inner ring fixed lower cover plate 2.7 clamps the cross roll bearing inner ring. The cross roll bearing outer ring fixed upper cover plate 2.6 and the cross roll bearing outer ring fixed lower cover plate 2.8 clamps an outer ring of the cross roll bearing. In addition, the cross roll bearing outer ring fixed upper cover plate 2.6 and the upper arm connecting seat 1.20 are fixed by using a thread. The entire rotation mechanism is completed. The wrist joint motor drive module and the wrist joint motor drive module are seen below.

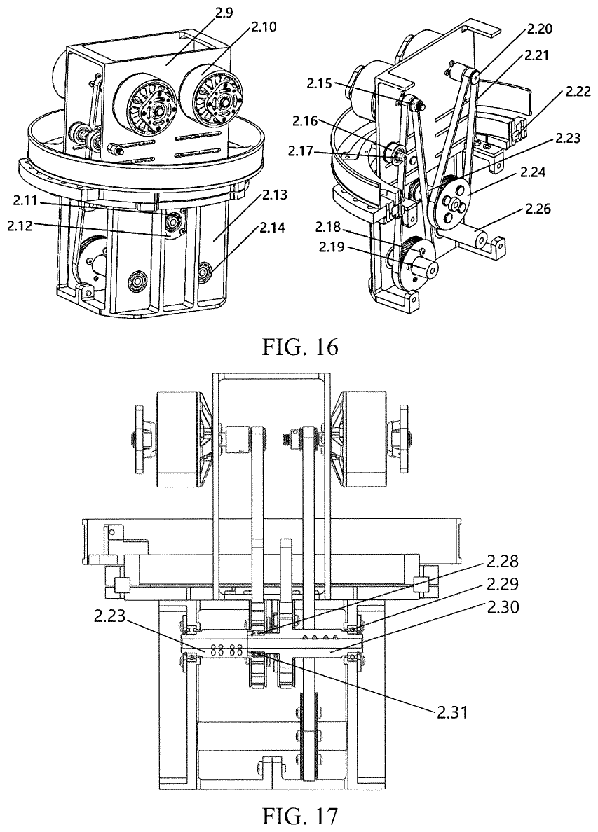

FIG. 16 shows a wrist joint motor drive module and an elbow joint motor drive module. This part is a symmetrical structure. Therefore, only a half part needs to be described. This module mainly includes a driving motor fixing seat 2.9, a drive motor 2.10, a snap spring 2.11, a bearing end cap 2.12, a pulley fixing seat 2.13, a deep groove ball bearing 2.14, a small wire wheel 1 2.15, a pulley bearing 2.16, a stud 2.17, a screw 2.18, a synchronous pulley 1 2.19, a small wire wheel 2 2.20, a synchronous belt 2.21, a cross roll bearing 2.22, an intermediate shaft 1 2.23, a wheel cover plate 2.24, a lock nut 2.25, a synchronous pulley 2 2.26, and a shoulder bearing 2.27. It can be seen that both the motor fixing seat 2.9 and the pulley shaft fixing seat 2.13 are connected to the cross roll bearing inner ring fixed lower cover plate 2.7 in FIG. 5, and rotate together with the large wire wheel 2.5. The drive motor 2.10 is fastened to the motor fixing seat 2.9 by using a screw. The drive motor 2.10 is connected to a small pulley 1 2.15 and a small pulley 2 2.20, and then motion is transmitted to the lower wire wheel shaft by using the synchronous belt 2.21, and the synchronous belt 2.21 is tightened by using the pulley bearing 2.16 and the stud 2.17. A connection manner of the synchronous pulley 1 2.19 and the synchronous pulley 2 2.26 is the same as that of the pulley fixing seat 2.13. The two synchronous belt axes are fixed by using two shoulder bearing 2.27 and a shoulder of the pulley fixing seat 2.13. The synchronous belt wheel is integrated with the shaft. To prevent the synchronous belt 2.21 from dragging out, wheel cover plates 2.24 is added to two sides of each synchronous pulley, and the synchronous belt wheel cover plate 2.24 is fixed to two sides of the wheel by using the lock nuts 2.25 and the screws 2.18. A connection manner of the intermediate shaft is a structure of a socket and is separately described below.

It can be seen from FIG. 17 that the connection between the intermediate shaft 1 2.23 and the intermediate shaft 2 2.30 is performed by using two deep groove ball bearing 2.28. In this way, relative rotation of the two axes can be implemented. An inner ring of the bearing is deadlocked by using a snap spring 2.31 and a shoulder of the intermediate shaft 2 2.30, and an outer ring is deadlocked by using a collar of the intermediate shaft 1 2.23 and a wheel cover plate 2.24. The outer sides of the two axes are both connected to the deep groove ball bearing 2.29, an inner ring of the bearing is deadly locked by using a shoulder and a snap spring, and an outer ring is deadly locked by using a pulley fixing seat 2.13 and a bearing end cap 2.12. The entire structure is compact, and has high transmission precision.

The following is an apparatus embodiment of this disclosure, which can be configured for executing the method embodiments of this disclosure. For details not disclosed in the apparatus embodiments of this disclosure, refer to the method embodiments of this disclosure.

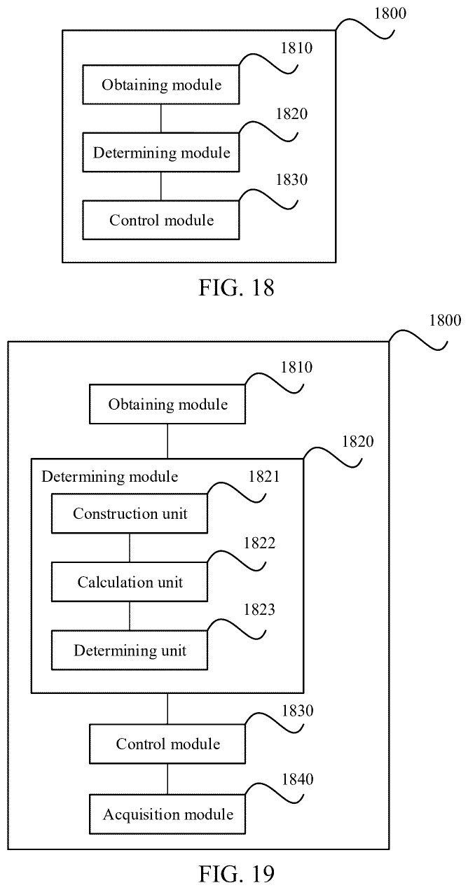

FIG. 18 is a block diagram of a robotic arm control apparatus according to an embodiment of this disclosure. The apparatus has a function of implementing the examples of the robotic arm control method. The function may be implemented by hardware, or may be implemented by hardware executing corresponding software. The apparatus may be the robotic arm described above, or may be arranged on the robotic arm. The apparatus 1800 may include an obtaining module 1810, a determining module 1820, and a control module 1830.

The obtaining module 1810 is configured to obtain historical data pairs at N moments, a historical data pair including historical input data and historical output data, the historical input data being configured for controlling motion of a robotic arm, to cause a first object to be kept in a balanced state on the robotic arm, the historical output data being configured for representing poses of the robotic arm and the first object after the robotic arm is controlled, based on the historical input data, to perform motion, and N being a positive integer.

The determining module 1820 is configured to determine predicted input data of the robotic arm at a current moment t based on the historical data pairs at the N moments.

The control module 1830 is configured to control, based on the predicted input data, the robotic arm to perform motion, the first object being balanced during motion of the robotic arm.

In some embodiments, as shown in FIG. 19, determining module 1820 includes a construction unit 1821, a calculation unit 1822, and a determining unit 1823.

The construction unit 1821 is configured to construct a constraint function and a cost function of the robotic arm based on the historical data pairs at the N moments, the constraint function being configured for describing a constraint condition that data needs to meet, the cost function being configured for representing a difference between predicted data and balance data, the balance data including input data and output data when the robotic arm and the first object are in an ideal balanced state, the predicted data including the predicted input data and predicted output data, and the predicted output data being obtained through prediction based on the historical output data.

The calculation unit 1822 is configured to calculate a unit impulse response of the robotic arm based on the constraint function and the cost function, the unit impulse response being configured for representing feedback from the robotic arm for the predicted input data.

The determining unit 1823 is configured to determine the predicted input data of the robotic arm at the current moment t based on the unit impulse response.

In some embodiments, the construction unit 1821 is configured to: determine a first matrix and a second matrix, the first matrix including historical input data in the historical data pairs at the N moments, and the second matrix including historical output data in the historical data pairs at the N moments; construct the constraint function of the robotic arm based on first n rows in the first matrix and first n rows in the second matrix, n being a system order of the robotic arm, and n being a positive integer; and construct the cost function of the robotic arm based on last L rows in the first matrix and last L rows in the second matrix, L being a predicted step of the robotic arm, and L being a positive integer, where historical data pairs of the robotic arm at first n moments are configured for predicting input data and output data of the robotic arm at last L moments.

In some embodiments, the construction unit 1821 is configured to determine historical input data from an (i−1)^{th} moment to an (N−L−n+i−1)^{th} moment in the N moments as an i^{th} row of the first matrix; and determine historical output data from an (i−1)^{th} moment to an (N−L−n+i−1)^{th} moment in the N moments as an i^{th} row of the second matrix, where i is a positive integer.

In some embodiments, the constraint function includes a first constraint function, a second constraint function, a third constraint function, and a fourth constraint function; and the construction unit 1821 is configured to: construct the first constraint function based on a slack variable, the slack variable being configured for describing measurement noise, and the first constraint function being configured for reducing interference of the measurement noise on the predicted input data; construct the second constraint function based on the first n rows in the first matrix and the first n rows in the second matrix, the second constraint function being configured for describing the historical data pairs at the first n moments; construct the third constraint function based on the first n rows in the first matrix, the first n rows in the second matrix, and the balance data, the third constraint function representing that the robotic arm is approximately in the ideal balanced state as time goes by; and construct the fourth constraint function based on the slack variable, a first boundary point, and the unit impulse response, the first boundary point being an upper limit of the slack variable, and the fourth constraint function being configured for constraining convergence of a process of predicting the predicted input data.

In some embodiments, the construction unit 1821 is configured to: construct a first norm based on the last L rows in the first matrix and the last L rows in the second matrix, where the first norm includes a second-order square norm of historical input data at the last L moments in the N moments, and a second-order square norm of historical output data at the last L moments in the N moments; construct a first penalty term based on a first penalty weight, a first boundary point, and a first regular term, the first regular term being a regularization penalty for the unit impulse response, the first penalty weight being a penalty weight for the first regular term, the first boundary point being an upper limit of a slack variable, and the slack variable being configured for describing measurement noise; construct a second penalty term based on a second penalty weight and a second regular term, the second regular term being a regularization penalty for the slack variable, and the second penalty weight being a penalty weight for the second regular term; and construct the cost function based on the first norm, the first penalty term, and the second penalty term.

In some embodiments, the determining unit 1823 is configured to: determine a third matrix based on the historical input data pairs at the N moments, the third matrix including a first matrix and a second matrix, the first matrix including historical input data in the historical data pairs at the N moments, and the second matrix including historical output data in the historical data pairs at the N moments; and calculate the predicted input data of the robotic arm at the current moment t based on the unit impulse response and the third matrix.

In some embodiments, the determining unit 1823 is configured to: construct a dynamics equation of the robotic arm based on a motion parameter of the first object and a motion parameter of the robotic arm, the motion parameter including at least one parameter affecting kinetic energy or potential energy, the dynamics equation including an underdrive equation and a drive equation, the underdrive equation being an equation whose input torque is 0, and the drive equation being an equation whose input torque is not 0; construct a state space equation of the robotic arm based on the underdrive equation and the third matrix, the state space equation being configured for describing a motion state of the robotic arm; and calculate the predicted input data of the robotic arm at the current moment t based on the state space equation and the drive equation, where the motion parameter includes at least one of the following: a length of the robotic arm, a specification of the first object, a mass of the robotic arm, a mass of the first object, a moment of inertia of the robotic arm, and a moment of inertia of the first object.

In some embodiments, the determining unit 1823 is configured to: calculate an input torque based on the state space equation and the drive equation, the input torque being configured for controlling rotation of a joint of the robotic arm; and determine the input torque as the predicted input data of the robotic arm at the current moment t.

In some embodiments, the determining unit 1823 is configured to: construct an initial dynamics equation of the robotic arm based on the motion parameter of the first object and the motion parameter of the robotic arm; and perform partial feedback linearization on the initial dynamics equation to obtain the dynamics equation, the partial feedback linearization being to perform linearized approximation on the initial dynamics equation.

In some embodiments, the determining unit 1823 is configured to: calculate a rotation angular velocity of a joint of the robotic arm based on the unit impulse response and the third matrix; and determine the rotation angular velocity as the predicted input data of the robotic arm at the current moment t.

In some embodiments, as shown in FIG. 19, the apparatus 1800 further includes an acquisition module 1840.

The acquisition module 1840 is configured to: obtain, for the current moment t, historical data pairs at a plurality of consecutive historical moments before the current moment t; and uniformly sample the historical data pairs at the plurality of consecutive historical moments, to obtain the historical data pairs at the N moments.

In some embodiments, the obtaining module 1810 is configured to: obtain, for a j^{th} moment in the N moments, historical input data at the j^{th} moment, j being a positive integer less than or equal to N; determine a pose of the robotic arm after the robotic arm performs motion based on the historical input data at the j^{th} moment; obtain a first position of the first object on the robotic arm based on a tactile sensor; obtain an image of the first object at the j^{th} moment; obtain a second position of the first object on the robotic arm based on the image of the first object; determine a centroid position of the first object based on the first position and the second position; and determine historical output data of the robotic arm at the j^{th} moment based on the centroid position of the first object and the pose of the robotic arm after the robotic arm performs motion based on the historical input data at the j^{th} moment.

In the technical solutions provided in embodiments of this disclosure, historical data pairs at a plurality of moments are obtained, so that input data of the robotic arm is predicted to obtain predicted input data, and motion of the robotic arm is controlled based on the predicted input data, to complete a task of balancing the first object on the robotic arm. A future system state of the robotic arm is predicted based on historical data without only depending on a feedback variable of a robotic arm system. Therefore, a response to control is more rapid.

When the apparatus provided in the foregoing embodiments implements functions of the apparatus, the division of the foregoing functional modules is merely an example for description. In the practical application, the functions may be assigned to and completed by different functional modules according to the requirements, that is, the internal structure of the device is divided into different functional modules, to implement all or some of the functions described above. In addition, the apparatus and method embodiments provided in the foregoing embodiments belong to the same concept. For the specific implementation process, refer to the method embodiments, and details are not described herein again.

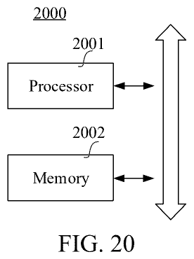

FIG. 20 is a structural block diagram of a robotic arm according to an embodiment of this disclosure. The robotic arm 2000 may be the robotic arm described above.

Generally, the robotic arm 2000 includes a processor 2001 and a memory 2002.

The processor 2001 may include one or more processing cores, for example, a 4-core processor or a 20-core processor. The processor 2001 may be implemented by using at least one hardware form of a digital signal processor (DSP), a field programmable gate array (FPGA), and a programmable logic array (PLA). The processor 2001 may alternatively include a main processor and a coprocessor. The main processor is configured to process data in an awake state, also referred to as a central processing unit (CPU). The coprocessor is a low-power processor configured to process data in a standby state. In some embodiments, the processor 2001 may be integrated with a graphics processing unit (GPU). The GPU is configured to render and draw content that needs to be displayed on a display screen. In some embodiments, the processor 2001 may further include an artificial intelligence (AI) processor. The AI processor is configured to process computing operations related to machine learning.

The memory 2002 may include one or more computer-readable storage media. The computer-readable storage medium may be tangible and non-transient. The memory 2002 may further include a high-speed random access memory (RAM), and a non-volatile memory such as one or more magnetic disk storage devices or flash storage devices. In some embodiments, a non-transient computer-readable storage medium in the memory 2002 stores a computer program, and the computer program is loaded and executed by the processor 2001 to implement the robotic arm control method provided in the foregoing method embodiments.

In an embodiment, a computer-readable storage medium is provided, storing a computer program, the computer program, when executed by a processor, implementing the robotic arm control method.

In an embodiment, the computer-readable storage medium may include: a read-only memory (ROM), a random access memory (RAM), a solid state drive (SSD), an optical disc, or the like. The RAM may include a resistance random access memory (ReRAM) and a dynamic random access memory (DRAM).

In an embodiment, a computer program product is further provided, the computer program product including a computer program, the computer program being stored in a computer-readable storage medium. A processor of a robot reads the computer program from the computer-readable storage medium, and the processor executes the computer program, to cause the robot to perform the robotic arm control method.

“A plurality of” mentioned in the specification means two or more. “And/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method for robotic arm control, comprising:
obtaining historical data pairs at N moments, a historical data pair at a moment comprising input data at the moment, and output data at the moment, the input data controlling a motion of a robotic arm at the moment, to cause a first object to be kept in a balanced state on the robotic arm, the output data representing poses of the robotic arm and the first object at the moment when the robotic arm is controlled based on the input data at the moment, and N being a positive integer;
determining predicted input data of the robotic arm at a current moment based on the historical data pairs at the N moments; and
controlling, based on the predicted input data, a motion of the robotic arm at the current moment, the first object being balanced during the motion of the robotic arm.

2. The method according to claim 1, wherein the determining the predicted input data comprises:
constructing a constraint function and a cost function of the robotic arm based on the historical data pairs at the N moments, the constraint function describing a constraint condition to meet by the robotic arm, the cost function representing a difference between predicted data and balance data, the balance data comprising input data and output data when the robotic arm and the first object are in an ideal balanced state, the predicted data comprising the predicted input data and predicted output data, and the predicted output data being obtained by prediction based on respective output data at the N moments in the historical data pairs at the N moments;
calculating a unit impulse response of the robotic arm based on the constraint function and the cost function, the unit impulse response representing feedback from the robotic arm for the predicted input data; and
determining the predicted input data of the robotic arm at the current moment based on the unit impulse response.

3. The method according to claim 2, wherein the constructing comprises:
determining a first matrix and a second matrix, the first matrix comprising respective input data at the N moments in the historical data pairs at the N moments, and the second matrix comprising the respective output data at the N moments;
constructing the constraint function of the robotic arm based on first n rows in the first matrix and first n rows in the second matrix, n being a system order of the robotic arm, and n being a positive integer; and
constructing the cost function of the robotic arm based on last L rows in the first matrix and last L rows in the second matrix, L being a predicted step of the robotic arm, and L being a positive integer, respective input data and respective output data at last L moments in the N moments being predicted based on respective input data and respective output data at first n moments in the N moments.

4. The method according to claim 3, wherein the determining the first matrix and the second matrix comprises:
selecting respective input data from an (i−1)^{th} moment to an (N−L−n+i−1)^{th} moment in the N moments as an i^{th} row of the first matrix, i being a positive integer; and
selecting respective output data from an (i−1)^{th} moment to an (N−L−n+i−1)^{th} moment in the N moments as an i^{th} row of the second matrix.

5. The method according to claim 3, wherein:
the constraint function comprises at least a first constraint function, a second constraint function, a third constraint function, and a fourth constraint function,
the constructing the constraint function comprises:
constructing the first constraint function based on a slack variable, the slack variable describing measurement noise, and the first constraint function being configured for reducing interference of the measurement noise on the predicted input data;
constructing the second constraint function based on the first n rows in the first matrix and the first n rows in the second matrix, the second constraint function describing historical data pairs at the first n moments;
constructing the third constraint function based on the first n rows in the first matrix, the first n rows in the second matrix, and the balance data, the third constraint function representing that the robotic arm approximates the ideal balanced state as time goes by; and
constructing the fourth constraint function based on the slack variable, a first boundary point, and the unit impulse response, the first boundary point being an upper limit of the slack variable, and the fourth constraint function constraining convergence of a predicting process of the predicted input data.

6. The method according to claim 3, wherein the constructing the cost function comprises:
constructing a first norm based on the last L rows in the first matrix and the last L rows in the second matrix, the first norm comprising a second-order square norm of the respective input data at the last L moments in the N moments, and a second-order square norm of the respective output data at the last L moments in the N moments;
constructing a first penalty term based on a first penalty weight, a first boundary point, and a first regular term, the first regular term being a regularization penalty for the unit impulse response, the first penalty weight being a penalty weight for the first regular term, the first boundary point being an upper limit of a slack variable, and the slack variable describing measurement noise;
constructing a second penalty term based on a second penalty weight and a second regular term, the second regular term being a regularization penalty for the slack variable, and the second penalty weight being a penalty weight for the second regular term; and
constructing the cost function based on the first norm, the first penalty term, and the second penalty term.

7. The method according to claim 2, wherein the determining the predicted input data of the robotic arm at the current moment based on the unit impulse response comprises:
determining a third matrix based on the historical data pairs at the N moments, the third matrix comprising a first matrix and a second matrix, the first matrix comprising respective input data at the N moments, and the second matrix comprising the respective output data at the N moments; and
calculating the predicted input data of the robotic arm at the current moment based on the unit impulse response and the third matrix.

8. The method according to claim 7, wherein the calculating the predicted input data of the robotic arm at the current moment based on the unit impulse response and the third matrix comprises:
constructing a dynamics equation of the robotic arm based on a first motion parameter of the first object and a second motion parameter of the robotic arm, the first motion parameter comprising at least one parameter affecting kinetic energy or potential energy of the first object, the second motion parameter comprising at least one parameter affecting kinetic energy or potential energy of the robotic arm, the dynamics equation comprising an underdrive equation and a drive equation, the underdrive equation being an equation with zero input torque, and the drive equation being an equation with non-zero input torque;
constructing a state space equation of the robotic arm based on the underdrive equation and the third matrix, the state space equation describing a motion state of the robotic arm; and
calculating the predicted input data of the robotic arm at the current moment based on the state space equation and the drive equation.

9. The method according to claim 8, wherein:
the first motion parameter comprises at least one of: a specification of the first object, a mass of the first object, and a moment of inertia of the first object; and
the second motion parameter comprises at least one of: a length of the robotic arm, a mass of the robotic arm, and a moment of inertia of the robotic arm.

10. The method according to claim 8, wherein the calculating the predicted input data of the robotic arm at the current moment based on the state space equation and the drive equation comprises:
calculating an input torque based on the state space equation and the drive equation, the input torque controlling a rotation of a joint of the robotic arm; and
determining the predicted input data of the robotic arm at the current moment based on the input torque.

11. The method according to claim 8, wherein the constructing the dynamics equation comprises:
constructing an initial dynamics equation of the robotic arm based on the first motion parameter of the first object and the second motion parameter of the robotic arm; and
performing partial feedback linearization on the initial dynamics equation to obtain the dynamics equation, the partial feedback linearization performing linearized approximation on the initial dynamics equation.

12. The method according to claim 7, wherein the calculating the predicted input data of the robotic arm at the current moment based on the unit impulse response and the third matrix comprises:
calculating a rotation angular velocity of a joint of the robotic arm based on the unit impulse response and the third matrix; and
determining the predicted input data of the robotic arm at the current moment based on the rotation angular velocity.

13. The method according to claim 1, further comprising:
obtaining, for the current moment, initial historical data pairs at a plurality of consecutive historical moments before the current moment; and
sampling the initial historical data pairs to obtain the historical data pairs at the N moments.

14. The method according to claim 1, wherein the obtaining the historical data pairs at N moments comprises:
obtaining, for a j^{th} moment in the N moments, input data at the j^{th} moment, j being a positive integer less than or equal to N;
determining a pose of the robotic arm when the robotic arm performs a motion based on the input data at the j^{th} moment;
obtaining a first position of the first object on the robotic arm based on a tactile sensor;
obtaining an image of the first object at the j^{th} moment;
obtaining a second position of the first object on the robotic arm based on the image of the first object;
determining a centroid position of the first object based on the first position and the second position; and
determining output data of the robotic arm at the j^{th} moment based on the centroid position of the first object and the pose of the robotic arm after the robotic arm performs a motion based on the input data at the j^{th} moment.

15. An apparatus for controlling a robotic arm, comprising processing circuitry configured to:
obtain historical data pairs at N moments, a historical data pair at a moment comprising input data at the moment, and output data at the moment, the input data controlling a motion of the robotic arm at the moment, to cause a first object to be kept in a balanced state on the robotic arm, the output data representing poses of the robotic arm and the first object at the moment when the robotic arm is controlled based on the input data at the moment, and N being a positive integer;
determine predicted input data of the robotic arm at a current moment based on the historical data pairs at the N moments; and
control, based on the predicted input data, a motion of the robotic arm at the current moment, the first object being balanced during the motion of the robotic arm.

16. The apparatus according to claim 15, wherein the processing circuitry is configured to:
construct a constraint function and a cost function of the robotic arm based on the historical data pairs at the N moments, the constraint function describing a constraint condition to meet by the robotic arm, the cost function representing a difference between predicted data and balance data, the balance data comprising input data and output data when the robotic arm and the first object are in an ideal balanced state, the predicted data comprising the predicted input data and predicted output data, and the predicted output data being obtained by prediction based on respective output data at the N moments in the historical data pairs at the N moments;
calculate a unit impulse response of the robotic arm based on the constraint function and the cost function, the unit impulse response representing feedback from the robotic arm for the predicted input data; and
determine the predicted input data of the robotic arm at the current moment based on the unit impulse response.

17. The apparatus according to claim 16, wherein the processing circuitry is configured to:
determine a first matrix and a second matrix, the first matrix comprising respective input data at the N moments in the historical data pairs at the N moments, and the second matrix comprising the respective output data at the N moments;
construct the constraint function of the robotic arm based on first n rows in the first matrix and first n rows in the second matrix, n being a system order of the robotic arm, and n being a positive integer; and
construct the cost function of the robotic arm based on last L rows in the first matrix and last L rows in the second matrix, L being a predicted step of the robotic arm, and L being a positive integer, respective input data and respective output data at last L moments in the N moments being predicted based on respective input data and respective output data at first n moments in the N moments.

18. The apparatus according to claim 17, wherein the processing circuitry is configured to:
select respective input data from an (i−1)^{th} moment to an (N−L−n+i−1)^{th} moment in the N moments as an i^{th} row of the first matrix, i being a positive integer; and
select respective output data from an (i−1)^{th} moment to an (N−L−n+i−1)^{th} moment in the N moments as an i^{th} row of the second matrix.

19. The apparatus according to claim 17, wherein:
the constraint function comprises at least a first constraint function, a second constraint function, a third constraint function, and a fourth constraint function,
the processing circuitry is configured to:
construct the first constraint function based on a slack variable, the slack variable describing measurement noise, and the first constraint function being configured for reducing interference of the measurement noise on the predicted input data;
construct the second constraint function based on the first n rows in the first matrix and the first n rows in the second matrix, the second constraint function describing historical data pairs at the first n moments;
construct the third constraint function based on the first n rows in the first matrix, the first n rows in the second matrix, and the balance data, the third constraint function representing that the robotic arm approximates the ideal balanced state as time goes by; and
construct the fourth constraint function based on the slack variable, a first boundary point, and the unit impulse response, the first boundary point being an upper limit of the slack variable, and the fourth constraint function constraining convergence of a predicting process of the predicted input data.

20. A non-transitory computer-readable storage medium storing instructions which when executed by at least one processor cause the at least one processor to perform:
obtaining historical data pairs at N moments, a historical data pair at a moment comprising input data at the moment, and output data at the moment, the input data controlling a motion of a robotic arm at the moment, to cause a first object to be kept in a balanced state on the robotic arm, the output data representing poses of the robotic arm and the first object at the moment when the robotic arm is controlled based on the input data at the moment, and N being a positive integer;
determining predicted input data of the robotic arm at a current moment based on the historical data pairs at the N moments; and
controlling, based on the predicted input data, a motion of the robotic arm at the current moment, the first object being balanced during the motion of the robotic arm.
